(19) United States
(12) Patent Application Publication
(10) Pub. No.: US 2025/0294638 A1
(43) Pub. Date: Sep. 18, 2025

(54) METHOD, DEVICE AND COMPUTER PROGRAM PRODUCT FOR WIRELESS COMMUNICATION

(71) Applicant: ZTE CORPORATION, Shenzhen (CN)

(72) Inventors: Qiujin GUO, Shenzhen (CN); Mengzhu CHEN, Shenzhen (CN); Bo DAI, Shenzhen (CN); Jun XU, Shenzhen (CN); Xiaoying MA, Shenzhen (CN); Xuan MA, Shenzhen (CN); Hong TANG, Shenzhen (CN)

(73) Assignee: ZTE CORPORATION, Shenzhen (CN)

(21) Appl. No.: 19/222,274

(22) Filed: May 29, 2025

Related U.S. Application Data
(63) Continuation of application No. PCT/CN2023/075771, filed on Feb. 13, 2023.

(51) Int. Cl. H04W 76/28

(52) U.S. Cl. CPC H04W 76/28

(57) ABSTRACT

A wireless communication method is disclosed. The method comprises receiving, by a wireless communication terminal from a wireless communication node, cell configuration information for a cell discontinuous communication; and performing, by the wireless communication terminal, the cell discontinuous communication according to the cell configuration information.

### CROSS-REFERENCE TO RELATED PATENT APPLICATIONS

This application is a Continuation of PCT Application No. PCT/CN2023/075771, filed Feb. 13, 2023, incorporated herein by reference in its entirety.

### TECHNICAL FIELD

This document is directed generally to wireless communications.

### BACKGROUND

The DRX (Discontinuous Reception) for UEs (user equipments) can be used to reduce the power consumption of UEs and network nodes. Further developments and applications of the DRX or similar discontinuous communication are widely discussed.

### SUMMARY

This document relates to methods, systems, and computer program products for a cell discontinuous communication.

One aspect of the present disclosure relates to a wireless communication method. In an embodiment, the wireless communication method includes: receiving, by a wireless communication terminal from a wireless communication node, cell configuration information for a cell discontinuous communication; and performing, by the wireless communication terminal, the cell discontinuous communication according to the cell configuration information.

Another aspect of the present disclosure relates to a wireless communication method. In an embodiment, the wireless communication method includes: transmitting, by a wireless communication node to a wireless communication terminal, cell configuration information for a cell discontinuous communication, to allow the wireless communication terminal to perform the cell discontinuous communication according to the cell configuration information.

Another aspect of the present disclosure relates to a wireless communication terminal. In an embodiment, the wireless communication terminal includes a communication unit and a processor. The processor is configured to: receive, via the communication unit from a wireless communication node, cell configuration information for a cell discontinuous communication; and perform the cell discontinuous communication according to the cell configuration information.

Another aspect of the present disclosure relates to a wireless communication node. In an embodiment, the wireless communication node includes a communication unit and a processor. The processor is configured to: transmit, via the communication unit to a wireless communication terminal, cell configuration information for a cell discontinuous communication, to allow the wireless communication terminal to perform the cell discontinuous communication according to the cell configuration information.

Various embodiments may preferably implement the following features:

Preferably or in some embodiments, the cell discontinuous communication comprises at least one of a discontinuous transmission, DTX, or a discontinuous reception, DRX.

Preferably or in some embodiments, for the cell discontinuous communication in a serving cell, during a cell discontinuous transmission active time, the wireless communication terminal performs at least one of:
monitoring a physical downlink control channel, PDCCH;
receiving a physical downlink shared channel, PDSCH;
transmitting a physical uplink control channel, PUCCH;
transmitting a physical downlink shared channel, PUSCH;
transmitting sounding reference signal, SRS, transmission;
performing channel state information, CSI, measurement;
reporting CSI report information;
monitoring a Random Access Response, RAR, or receiving an MsgB during a time window; or
starting, restarting, or keeping a first timer running,
wherein monitoring the PDCCH comprises at least one of monitoring a first PDCCH or monitoring a second PDCCH.

Preferably or in some embodiments, the first timer comprises at least one of a timer related to search space set group 1, SSSG1, or search space set group 2, SSSG2, for a PDCCH monitoring adaptation, or skipping a duration for a PDCCH monitoring adaptation, a bwp-InactivityTimer, a timer configured with a user equipment, UE, Connected Mode DRX, CDRX, a timer of a cell discontinuous communication on-duration, a timer of the cell discontinuous communication for data reception or transmission, a timer of a cell discontinuous communication active time, a timer of a cell discontinuous communication activation or enabling, a timer of a cell discontinuous communication deactivation or disabling, a timer of a cell discontinuous communication cycle, or a timer of the cell discontinuous communication.

Preferably or in some embodiments, the cell discontinuous transmission active time comprises one or more of the following periods:
an Active Time of a user equipment, UE, DRX for the wireless communication terminal;
a period when a timer is running during a cell discontinuous communication cycle, in which the timer is configured for the cell discontinuous communication;
a period when a timer is running during a cell discontinuous communication cycle that is related to hybrid automatic repeat request acknowledgment, HARQ-ACK, information and/or a random access channel, RACH, procedure, in which the timer is configured for the cell discontinuous communication;
a period after that the wireless communication terminal reports HARQ-ACK information for a data transmission;
a period after that the wireless communication terminal reports a negative acknowledgment, NACK, for a data transmission;
a time duration between the wireless communication terminal reports a NACK for a data transmission and the wireless communication terminal receives data successfully;
a period when a timer related to a data retransmission executing during a cell discontinuous communication cycle is running;
a period when a drx-onDurationTimer or a drx-InactivityTimer is running;
a period when a drx-RetransmissionTimerDL, a drx-RetransmissionTimerUL or a drx-RetransmissionTimerSL is running;
a period after the wireless communication terminal is performing a Scheduling Request procedure;
a period when the wireless communication terminal is in a time window to monitor an RAR and/or receive an MsgB;
a cell discontinuous communication on-duration;
a period when a first timer is running; or
a period of a second cell discontinuous communication-duration.

Preferably or in some embodiments, a second cell discontinuous communication-duration comprises at least one of:
a period for receiving a PDSCH for an initial transmission or a retransmission;
a period after an end of the cell discontinuous communication on-duration;
a period after the detection of the first or second PDCCH;
a period after a detection of a PDCCH scheduling a PDSCH or PUSCH;
a period after receiving a PDSCH or transmitting a PUSCH;
a period before a start of a next cell discontinuous communication cycle; or
a period before an end of a consecutive duration of a UE CDRX Active Time.

Preferably or in some embodiments, for the cell discontinuous communication in a serving cell, outside a cell discontinuous communication active time, the wireless communication terminal performs at least one of:
refraining from transmitting a Sounding Reference Signal, SRS;
refraining from reporting channel status information, CST;
refraining from transmitting data on an uplink shared channel, UL-SCH;
refraining from transmitting on a RACH;
refraining from monitoring a first PDCCH;
refraining from monitoring a first PDCCH on a secondary cell, SCell, or for the SCell;
refraining from transmitting a physical uplink control channel, PUCCH;
refraining from receiving a downlink shared channel, DL-SCH;
cancelling an ongoing Random Access procedure;
stopping a first timer;
receiving a semi-persistent scheduling, SPS, physical downlink shared channel, PDSCH, reception; or
transmitting a configured grant, CG, physical uplink shared channel, PUSCH.

Preferably or in some embodiments, for a cell DTX in the cell discontinuous communication, the wireless communication terminal performs one or more first terminal behaviors comprising at least one of:
a measurement based on a reference signal, RS, common signals, or common channels;
a first PDCCH monitoring,
a semi-persistent scheduling, SPS, physical downlink shared channel, PDSCH, reception,
a PDSCH reception, or
a reception associated with a RACH procedure.

Preferably or in some embodiments, the reference signal comprises at least one of: a channel status information reference signal, CSI-RS, a semi-persistent CSI-RS, or an aperiodic CSI-RS, remote interference management reference signal, RIM-RS, positioning reference signal, PRS, a synchronization signal physical broadcast channel, SS/PBCH, block, a phase-tracking reference signal, PT-RS, a secondary synchronization signal, SSS, or a primary synchronization signal, PSS.

Preferably or in some embodiments, the first PDCCH monitoring comprises at least one of: a monitoring of a PDCCH carrying downlink, DL, scheduling information, or a monitoring of a PDCCH carrying at least one of Downlink Control Information, DCI, with a DCI format 1-0, DCI with a DCI format 1-1, DCI with a DCI format 1-2, DCI with a DCI format 2-0, DCI with a DCI format 2-1, DCI with a DCI format 2-2, DCI with a DCI format 2-3, DCI with a DCI format 2-4, DCI with a DCI format 2-5, DCI with a DCI format 2-6, or DCI with a DCI format 2-7; or a cyclic redundancy check, CRC of the first PDCCH is scrambled by a Cell Radio Network Temporary Identifier, C-RNTI, a Cancellation Indication RNTI, CI-RNTI, a Configured Scheduling RNTI, CS-RNTI, an Interruption RNTI, INT-RNTI, a Slot Format Indication RNTI, SFI-RNTI, a Semi-Persistent CSI RNTI, SP-CSI-RNTI, a Transmit Power Control-PUCCH-RNTI, TPC-PUCCH-RNTI, a Transmit Power Control-PUSCH-RNTI, TPC-PUSCH-RNTI, a Transmit Power Control-Sounding Reference Symbols-RNTI, TPC-SRS-RNTI, an Availability Indication RNTI, AI-RNTI, a Sidelink RNTI, SL-RNTI, a Sidelink Configured Scheduling RNTI, SLCS-RNTI or a Sidelink Semi-Persistent Scheduling Vehicle RNTI, V-RNTI.

Preferably or in some embodiments, the wireless communication terminal performs the one or more first terminal behaviors for the cell DTX in response to at least one of the following conditions:
the wireless communication terminal is in a cell DTX active time;
the wireless communication terminal is in a cell DTX on-duration;
the wireless communication terminal is in a cell DTX cycle; or
the wireless communication terminal is in a period of a cell DTX on-duration or a cell DTX active time overlapped with a UE DRX on-duration or a UE DRX active time for the wireless communication terminal.

Preferably or in some embodiments, for a cell DRX in the cell discontinuous communication, the wireless communication terminal performs one or more second terminal behaviors comprising at least one of:
an SRS transmission,
a second PDCCH monitoring,
a scheduling request, SR, transmission,
a Configured Grant Physical Uplink Shared Channel, CG-PUSCH, transmission,
a PUCCH, or physical uplink shared channel, PUSCH, transmission, or
a transmission associated with a RACH procedure.

Preferably or in some embodiments, the second PDCCH monitoring comprises at least one of: a monitoring of a PDCCH carrying uplink, UL, scheduling information, or a monitoring of a PDCCH carrying at least one of DCI with a DCI format 0-0, DCI with a DCI format 0-1, DCI with a DCI format 0-2, DCI with a DCI format 2-0, DCI with a DCI format 2-1, DCI with a DCI format 2-2, DCI with a DCI format 2-3, DCI with a DCI format 2-4, DCI with a DCI format 2-5, DCI with a DCI format 2-6, or DCI with a DCI format 2-7; or the CRC of the second PDCCH is scrambled by C-RNTI, CI-RNTI, CS-RNTI, INT-RNTI, SFI-RNTI, SP-CSI-RNTI, TPC-PUCCH-RNTI, TPC-PUSCH-RNTI, TPC-SRS-RNTI, AI-RNTI, SL-RNTI, SLCS-RNTI and/or SL Semi-Persistent Scheduling V-RNTI.

Preferably or in some embodiments, the wireless communication terminal performs one or more second terminal behaviors in the cell DRX in response to at least one of the following conditions:
the wireless communication terminal is in a cell DRX active time;
the wireless communication terminal is in a cell DRX on-duration;
the wireless communication terminal is in a cell DRX cycle; or
the wireless communication terminal is in a period of a cell DRX on-duration or a cell DRX active time overlapped with a UE DRX on-duration or a UE DRX active time for the wireless communication terminal.

Preferably or in some embodiments, for a cell DTX or a cell DRX, the wireless communication terminal performs one or more third terminal behaviors comprising at least one of a UE DRX operation for the wireless communication terminal, a timer behavior, one or more first terminal behaviors for the cell DTX, or one or more second terminal behaviors for the cell DRX.

Preferably or in some embodiments, the timer behavior comprises starting, restarting, running, or stopping a timer associated with the UE DRX operation, and the one or more first terminal behaviors for the cell DTX or the one or more second terminal behaviors for the cell DRX do not comprise starting, restarting, running, or stopping the timer associated with the UE DRX operation.

Preferably or in some embodiments, the cell configuration information comprises one or more configuration parameters comprising at least one of:
an indication to enable or disable a functionality of the cell discontinuous communication;
an indication to enable or disable one or more cell discontinuous communication cycles;
an indication to enable or disable one or more cell discontinuous communication on-durations;
a length of a cell discontinuous communication cycle;
a length of a cell discontinuous communication on-duration;
an indication to enable or disable at least one of a signal transmission or a signal reception;
one or more offsets for the cell discontinuous communication;
a cell DTX activation or deactivation;
a cell DRX activation or deactivation;
a starting position of the cell configuration information in layer 1, L1, signaling; or
a cell DTX or cell DRX activation or deactivation for a group of cells.

Preferably or in some embodiments, the at least one of a signal transmission or a signal reception comprises a transmission or a reception of at least one of an RS, uplink control information, UCI, a PUCCH, an SR, or a PDCCH.

Preferably or in some embodiments, the indication to enable or disable at least one of a signal transmission or a signal reception is applied to at least one of a cell discontinuous communication on-duration, a cell discontinuous communication active time, a cell discontinuous communication cycle, a cell discontinuous communication off-duration, or a time outside a cell discontinuous communication active time.

Preferably or in some embodiments, the one or more offsets comprise at least one of:
an offset used to determine a start of a cell DTX cycle;
an offset used to determine a start of a cell DTX on-duration;
an offset used to determine a start of a cell DTX active time;
an offset used to determine a start of a cell DRX cycle;
an offset used to determine a start of a cell DRX on-duration;
an offset used to determine a start of a cell DRX active time;
an offset between a start of a cell DTX cycle and a cell DRX cycle;
an offset between a start of a cell DTX on-duration and a cell DRX on-duration; or
an offset between a start of a cell DTX active time and a cell DRX active time.

Preferably or in some embodiments, the cell configuration information comprises at least one of a set of candidate values of the one or more configuration parameters; or one or more configuration sets comprising a set identifier and the one or more configuration parameters.

Preferably or in some embodiments, the one or more configuration sets satisfy at least one of the following:
one or more configuration parameters for a cell DTX in the one or more configuration sets are used for a cell DRX,
one or more configuration parameters for a cell DRX in the one or more configuration sets are used for a cell DTX, or
one or more configuration parameters for a cell DTX in the one or more configuration sets are used for both a cell DTX and a cell DRX.

Preferably or in some embodiments, the cell configuration information is provided through at least one of: Radio Resource Control, RRC, signaling; a Medium Access Control Control Element, MAC CE; DCI; or a System Information block, SIB.

Preferably or in some embodiments, one or more configuration sets of the cell configuration information are provided through at least one of: RRC signaling; a MAC CE; DCI; or a SIB.

Preferably or in some embodiments, a configuration of the cell discontinuous communication for the wireless communication terminal satisfies with at least one of:
the cell discontinuous communication is configured with one or more candidate values of UE DRX parameters for the wireless communication terminal;
one or more configuration parameters of the cell discontinuous communication is configured to have values the same as one or more UE DRX parameters for the wireless communication terminal;
one or more candidate values of one or more configuration parameters of a cell DTX is configured to have values the same as one or more candidate values of one or more UE DRX parameters for the wireless communication terminal;
one or more configuration parameters for a cell DTX are used as one or more UE DRX parameters for the wireless communication terminal;
one or more UE DRX parameters for the wireless communication terminal are used as one or more configuration parameters for a cell DTX; or
one or more configuration parameters are used for both a cell DTX and a UE DRX for the wireless communication terminal.

Preferably or in some embodiments, one or more configuration parameters of the cell discontinuous communication satisfy at least one of:
a length of a cell discontinuous communication cycle, on-duration, or off-duration is equal to a multiple of a value of one or more UE DRX parameters;
a length of a cell discontinuous communication cycle, on-duration, or off-duration is not shorter than 2 ms or is not greater than a product of n and 10240 ms, and n is an integer that is not smaller than 1;
a length of a cell discontinuous communication cycle, on-duration, or off-duration is an integer of δ*2;\m of symbols, slots, or milliseconds, wherein 8 is one of the following: 1, 3, 5, 7, 15, and 35, and wherein mis an integer that is not smaller than 0 and is not larger than 20; or a length of a cell discontinuous communication cycle, on-duration, or off-duration is n* 1/32 millisecond, wherein n is a positive integer that is not larger than 31.

Preferably or in some embodiments, one or more configuration parameters of the cell discontinuous communication are associated with at least one of the following UE DRX parameters for the wireless communication terminal:
a UE DRX on-duration timer;
a UE DRX inactivity timer;
a UE DRX HARQ round trip time, RTT, timer;
a UE DRX retransmission timer;
a UE DRX long cycle;
a UE DRX short cycle;
a multiple of a UE DRX short cycle and a UE DRX short cycle timer;
a start of a search time for a wake-up signal;
a search time for a wake-up signal;
an offset of a UE DRX long cycle or UE DRX short cycle; or
a power saving, PS, offset of a search time.

Preferably or in some embodiments, during a cell discontinuous communication cycle, different values of offsets of a cell DRX cycle, a cell DRX on-duration timer, or a DRX inactivity timer are allowed for different groups of cells, different cells, different groups of UEs, or different UEs.

Preferably or in some embodiments, one or more configuration parameters of the cell discontinuous communication satisfy at least one of:
one or more configuration parameters of a cell DTX are identical to one or more configuration parameters of a cell DRX; or
one or more candidate values of one or more configuration parameters for a cell DTX in one or more configuration sets are identical to one or more candidate values of one or more configuration parameters of a cell DRX in the one or more configuration sets.

Preferably or in some embodiments, the wireless communication terminal performs at least one of the following operations for a first cell and a second cell:
refraining from performing the cell discontinuous communication on the second cell according to the cell configuration information;
refraining from performing the cell discontinuous communication on the first cell according to the cell configuration information;
refraining from performing the cell discontinuous communication on both of the first and second cells according to the cell configuration information;
performing the cell discontinuous communication on the first cell according to the cell configuration information for the first cell; or
performing the cell discontinuous communication on the second cell according to the cell configuration information for the first cell.

Preferably or in some embodiments, the wireless communication terminal performs the at least one of the operations for the first cell and the second cell in response to the cell configuration information for the first cell and the second cell satisfying one or more predefined conditions comprise at least one of:
at least one of values between the cell configuration information for the first cell and the second cell is different;
a value in the cell configuration information for the first cell is smaller than a corresponding value in the cell configuration information for the second cell;
a value in the cell configuration information for the first cell is larger than a corresponding value in the cell configuration information for the second cell;
a value in the cell configuration information for the first cell is equal to a corresponding value in the cell configuration information for the second cell;
a number of parameters of the cell configuration information for the first cell is less than or more than or equal to a number of parameters of the cell configuration information for the second cell;
the cell discontinuous communication is activated on the first cell and deactivated on the second cell or the cell discontinuous communication is deactivated on the first cell and activated on the second cell;
the first cell is in a cell discontinuous communication on-duration or a cell discontinuous communication active time and the second cell is in a cell discontinuous communication off-duration or outside of a cell discontinuous communication active time, or the first cell is in a cell discontinuous communication off-duration or outside of a cell discontinuous communication active time and the second cell is in a cell discontinuous communication on-duration or a cell discontinuous communication active time; or
configuration parameters of the cell configuration information for the first cell are different from or are not align with configuration parameters of the cell configuration information for the second cell.

Preferably or in some embodiments, the first cell and the second cell satisfy at least one of the following conditions: the first cell is a primary cell and the second cell is a secondary cell; the first cell is a secondary cell and the second cell is another secondary cell; the first cell is a scheduling cell and the second cell is a scheduled cell; or the first cell and the second cell are the same cell.

Preferably or in some embodiments, the wireless communication terminal is configured with a carrier aggregation, CA, on a first cell and a second cell, at least one of the following occurs:
for a cross-carrier scheduling, the cell configuration information is not be applied to the first cell or the second cell;
at least one of UE DRX configuration information or the cell configuration information for the first cell and the second cell are the same; or
DCI with a DCI format 2-6 and the cell configuration information are not configured together.

Preferably or in some embodiments, in response to the wireless communication terminal detecting DCI scheduling information for data in a first cell, and the data being scheduled to be transmitted during a cell discontinuous communication off-duration on a second cell, the wireless communication terminal performs at least one of:
receiving or transmitting the data according to the DCI scheduling information;
receiving or transmitting the data during a cell discontinuous communication on-duration and/or a cell discontinuous communication active time in a next cell discontinuous communication cycle according to the DCI scheduling information;
assuming that the DCI scheduling information is invalid;
ignoring or not expecting the DCI scheduling information; or sending a request for the cell configuration information on the second cell.

Preferably or in some embodiments, the wireless communication terminal performs at least one of the following operations:
reporting a CSI report with certain quantities;
performing CSI measurements based on CSI measurement occasions during a time duration associated with at least one of a cell discontinuous communication cycle, a cell discontinuous communication on-duration, a cell discontinuous communication off-duration, a UE DRX cycle for the wireless communication terminal, or a UE DRX on-duration for the wireless communication terminal;
performing a measurement based on a CSI-RS-Resource-Mobility;
assuming a DRX on-duration timer during a cell discontinuous communication off-duration belonging to a UE DRX active time or a cell discontinuous communication active time; or
transmitting an SRS.

Preferably or in some embodiments, the wireless communication terminal performs the at least one of the operations in response to one or more following predefined conditions:
the wireless communication terminal is configured by a higher layer parameter;
the wireless communication terminal is configured to report a CSI report with certain quantities;
a most recent CSI measurement occasion occurs in a time duration associated with at least one of a cell discontinuous communication cycle, a cell discontinuous communication on-duration, a cell discontinuous communication off-duration, a UE DRX cycle for the wireless communication terminal, or a UE DRX on-duration for the wireless communication terminal for CSI to be reported;
the wireless communication terminal is configured by higher layer parameter to report a layer 1 reference signal received power, L1-RSRP;
a CSI report is set to periodic or semi-persistent;
the wireless communication terminal is configured to transmit an SRS; or
the wireless communication terminal does not satisfy with at least one of the following conditions:
a drx-onDurationTimer associated with a current DRX cycle is not started;
a DRX is not in a UE DRX active time;
a UE DRX Command MAC CE or a UE Long DRX Command MAC CE is received;
a Scheduling Request is sent prior to an occasion, slot, or symbol evaluating all UE DRX Active Time conditions;
the wireless communication terminal is refrained from reporting periodic CSI on a PUCCH or semi-persistent CSI on a PUSCH; or
the wireless communication terminal is refrained from transmitting an SRS.

Preferably or in some embodiments, the wireless communication terminal does not perform the measurement based on the CSI-RS-Resource-Mobility other than during a time duration associated with at least one of a cell discontinuous communication cycle, a cell discontinuous communication on-duration, a cell discontinuous communication off-duration, a UE DRX cycle for the wireless communication terminal, or a UE DRX on-duration for the wireless communication terminal.

Preferably or in some embodiments, the time duration associated with at least one of a cell discontinuous communication cycle, a cell discontinuous communication on-duration, a cell discontinuous communication off-duration, a UE DRX cycle for the wireless communication terminal, or a UE DRX on-duration for the wireless communication terminal comprises at least one of:
a cell discontinuous communication active time;
a period outside a cell discontinuous communication active time;
a cell discontinuous communication off-duration;
a cell discontinuous communication on-duration;
a timer duration indicated by a drx-onDurationTimer in a DRX configuration outside a cell discontinuous communication active time or in a cell discontinuous communication off-duration;
a timer duration indicated by a drx-onDurationTimer in a DRX configuration outside a UE DRX active time and outside a cell discontinuous communication active time or a cell discontinuous communication off-duration;
a timer duration indicated by a drx-onDurationTimer in a DRX configuration in a cell discontinuous communication active time or a cell discontinuous communication on-duration;
a timer duration indicated by a drx-onDurationTimer in a DRX configuration outside a UE DRX active time and in a cell discontinuous communication active time or a cell discontinuous communication on-duration;
a timer duration of a UE DRX active time in a cell discontinuous communication active time or a cell discontinuous communication on-duration;
a timer duration of a UE DRX active time outside a cell discontinuous communication active time or in a cell discontinuous communication off-duration;
a timer duration of outside a UE DRX active time in a cell discontinuous communication active time, or in a cell discontinuous communication on-duration; or
a timer duration of outside a UE DRX active time outside a cell discontinuous communication active time or in a cell discontinuous communication off-duration.

The present disclosure relates to a computer program product comprising a computer-readable program medium code stored thereupon, the code, when executed by a processor, causing the processor to implement a wireless communication method recited in any one of foregoing methods.

The example embodiments disclosed herein are directed to providing features that will become readily apparent by reference to the following description when taken in conjunction with the accompany drawings. In accordance with various embodiments, example systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the example embodiments and applications described and illustrated herein. Additionally, the specific order and/or hierarchy of steps in the methods disclosed herein are merely example approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

### BRIEF DESCRIPTION OF THE DRAWINGS

The above and other aspects and their implementations are described in greater detail in the drawings, the descriptions, and the claims.

FIG. 1 shows an example of a schematic diagram of a wireless terminal according to an embodiment of the present disclosure.

FIG. 2 shows an example of a schematic diagram of a wireless network node according to an embodiment of the present disclosure.

FIG. 3 shows an example of the cell DTX/DRX in accordance with an embodiment of the present disclosure.

FIG. 4 shows an example of the cell DTX/DRX in accordance with an embodiment of the present disclosure.

FIG. 5 shows an example of the cell DTX/DRX in accordance with an embodiment of the present disclosure.

FIG. 6 shows an example of the cell DTX/DRX in accordance with an embodiment of the present disclosure.

FIG. 7 shows an example of the cell DTX/DRX in accordance with an embodiment of the present disclosure.

FIG. 8 shows an example of the cell DTX/DRX in accordance with an embodiment of the present disclosure.

FIG. 9 shows an example of the cell DTX/DRX in accordance with an embodiment of the present disclosure.

FIG. 10 shows an example of the cell DTX/DRX in accordance with an embodiment of the present disclosure.

FIG. 11 shows an example of the cell DTX/DRX in accordance with an embodiment of the present disclosure.

FIG. 12 shows an example of the cell DTX/DRX in accordance with an embodiment of the present disclosure.

FIG. 13 shows an example of the cell DTX/DRX in accordance with an embodiment of the present disclosure.

FIG. 14 shows an example of the cell DTX/DRX in accordance with an embodiment of the present disclosure.

FIG. 15 shows a flowchart in accordance with an embodiment of the present disclosure.

FIG. 16 shows a flowchart in accordance with an embodiment of the present disclosure.

### DETAILED DESCRIPTION

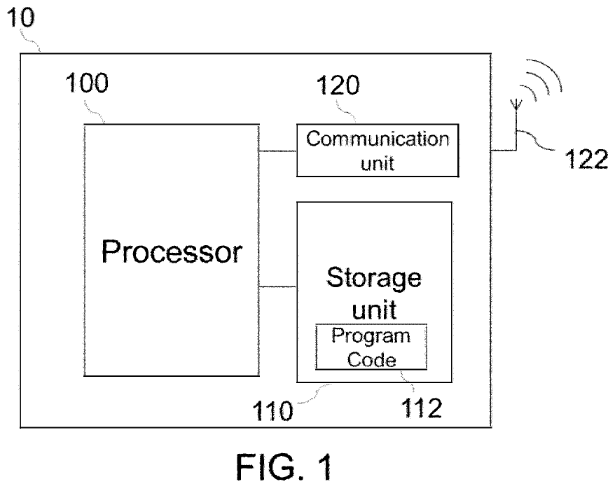

FIG. 1 relates to a schematic diagram of a wireless terminal 10 according to an embodiment of the present disclosure. The wireless terminal 10 may be a user equipment (UE), a mobile phone, a laptop, a tablet computer, an electronic book or a portable computer system and is not limited herein. The wireless terminal 10 may include a processor 100 such as a microprocessor or Application Specific Integrated Circuit (ASIC), a storage unit 110 and a communication unit 120. The storage unit 110 may be any data storage device that stores a program code 112, which is accessed and executed by the processor 100. Embodiments of the storage unit 110 include but are not limited to a subscriber identity module (SIM), read-only memory (ROM), flash memory, random-access memory (RAM), hard-disk, and optical data storage device. The communication unit 120 may a transceiver and is used to transmit and receive signals (e.g., messages or packets) according to processing results of the processor 100. In an embodiment, the communication unit 120 transmits and receives the signals via at least one antenna 122 shown in FIG. 1.

In an embodiment, the storage unit 110 and the program code 112 may be omitted and the processor 100 may include a storage unit with stored program code.

The processor 100 may implement any one of the steps in exemplified embodiments on the wireless terminal 10, e.g., by executing the program code 112.

The communication unit 120 may be a transceiver. The communication unit 120 may as an alternative or in addition be combining a transmitting unit and a receiving unit configured to transmit and to receive, respectively, signals to and from a wireless network node (e.g., a base station).

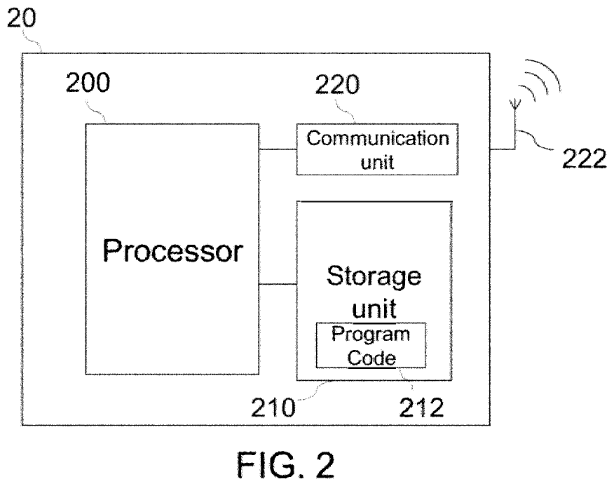

FIG. 2 relates to a schematic diagram of a wireless network node 20 according to an embodiment of the present disclosure. The wireless network node 20 may be a satellite, a base station (BS), a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 20 may comprise (perform) at least one network function such as an access and mobility management function (AMF), a session management function (SMF), a user place function (UPF), a policy control function (PCF), an application function (AF), etc. The wireless network node 20 may include a processor 200 such as a microprocessor or ASIC, a storage unit 210 and a communication unit 220. The storage unit 210 may be any data storage device that stores a program code 212, which is accessed and executed by the processor 200. Examples of the storage unit 210 include but are not limited to a SIM, ROM, flash memory, RAM, hard-disk, and optical data storage device. The communication unit 220 may be a transceiver and is used to transmit and receive signals (e.g. messages or packets) according to processing results of the processor 200. In an example, the communication unit 220 transmits and receives the signals via at least one antenna 222 shown in FIG. 2.

In an embodiment, the storage unit 210 and the program code 212 may be omitted. The processor 200 may include a storage unit with stored program code.

The processor 200 may implement any steps described in exemplified embodiments on the wireless network node 20, e.g., via executing the program code 212.

The communication unit 220 may be a transceiver. The communication unit 220 may as an alternative or in addition be combining a transmitting unit and a receiving unit configured to transmit and to receive, respectively, signals to and from a wireless terminal (e.g., a user equipment or another wireless network node).

In the paragraphs below, details will be described along with some examples, but the present disclosure is not limited to the example below.

In some approaches, the gNB (gNodeB) can use network DTX (data transmission)/DRX with restrictions based on the UE DRX configurations and configured transmissions/receptions, e.g., common channels/signals. C-DRX (Connected Mode Discontinuous Reception) may be configured per UE. The alignment of the DRX cycles or offsets for different UEs may be done only via RRC (Radio Resource Control) signaling. During the DRX off-duration, the UE does not expect to monitor the PDCCH (physical downlink control channel), but it is allowed to initiate the UL (uplink) transmission according to the configured resources (e.g., using the PUCCH or RACH (random access channel), or CG-PUSCH (configured grant Physical Uplink Shared Channel)).

Some embodiments of the present disclosure relate to adaptation of a cell DTX/DRX aiming at providing the necessary signaling mechanisms enabling the cell to stay inactive. The cell DTX/DRX may be configured by DE-specific RRC signaling. In some embodiments of the present disclosure, one or more of the following issues may be solved.

Issue I: How to ensure a longer gNB sleep period when the DTX/DRX operation is configured?

Issue 2: How to trigger the cell DTX/DRX activation/deactivation?

Issue 3: How to reduce the network congestion possibility when data transmissions for all UEs camping on the cell are scheduled on the same DRX on-duration?

Issue 4: For a UE or UEs not supporting the cell DTX/DRX, how to access the cell with the cell DTX/DRX?

In some embodiments, the adaptation of the cell DTX/DRX may provide signaling mechanisms enabling the cell to stay inactive. This includes enhancements to the UE DRX configuration, e.g., to align or omit DRX cycles or start offsets of DRX, for UEs in connected mode or idle/inactive mode, potentially allowing longer opportunities for cell inactivity. During a cell DTX/DRX, the cell may have no transmission/reception or only keep limited transmission/reception. For example, the cell does not need to transmit or receive some periodic signals/channels, such as common channels/signals or UE specific signals/channels.

In some embodiments, the cell DTX/DRX on duration is the time duration when the cell DTX/DRX on duration timer is running.

In some embodiments, the cell DTX/DRX may indicate at least one of the cell DTX and/or the cell DRX and/or alignment of cell DTX/DRX and UE DRX.

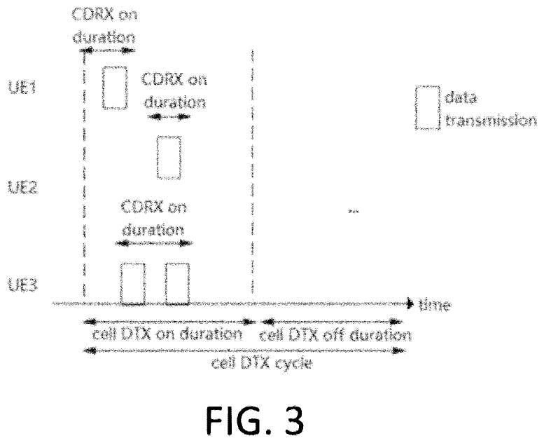

In some embodiments, the alignment of cell DTX/DRX and UE DRX means that the UE DRX on duration/Active Time falls into a time duration, and/or the gap between the start positions of UE DRX on duration/Active Time/cycle for two UEs is not larger than a threshold in a cell. In some embodiments, the threshold is an offset configured by RRC signaling or L1 signaling, and/or a predefined value. Wherein the threshold is not larger than the value of a cell DTX/DRX parameter. In some embodiments, the cell DTX/DRX parameter includes at least one of the cell DTX/DRX indication information. For example, the threshold is not larger than the value of cell DTX/DRX on duration or DTX/DRX on duration timer, and the start positions of UE DRX on duration are dropped into the cell DTX/DRX on duration configured or indicated by RRC signaling and/or L1 signaling. FIG. 3 shows an example of alignment of cell DTX/DRX and UE DRX, where UE DRX on durations fall into cell DTX on duration.

In some embodiments, when the UE is configured with UE DRX and cell DTX/DRX, the UE starts UE DRX cycle/on duration timer after UE DRX slot offset from the beginning of the subframe. In some embodiments, the subframe, SFN or the UE DRX slot offset is determined by one or more parameters. In some embodiments, the one or more parameters include at least one of UE ID, UE DRX slot offset, UE DRX start offset, UE DRX short cycle, UE DRX long cycle, SFN, UE DRX on duration timer, cell DTX/DRX start offset, cell DTX/DRX slot offset, cell DTX/DRX cycle, cell DTX/DRX on duration, or an offset. In some embodiments, at least one of the one or more parameters are configured by RRC signaling or L1 signaling.

In some embodiments, the subframe satisfies a function of at least one of parameters. In some embodiments, the one or more parameters include at least one of UE ID, UE DRX slot offset, UE DRX start offset, UE DRX short cycle, UE DRX long cycle, SFN, UE DRX on duration timer, cell DTX/DRX start offset, cell DTX/DRX slot offset, cell DTX/DRX cycle, cell DTX/DRX on duration, or an offset. In some embodiments, the SFN is the subframe number where at least one of the UE DRX on duration timer/cycle or the cell DTX/DRX cycle/on duration timer starts from. In some embodiments, the offset is used to modify at least one of the UE DRX slot offset, UE DRX start offset, cell DTX/DRX start offset, or cell DTX/DRX slot offset.

For example, the subframe for the start of cell DTX/DRX on duration/cycle (noted as dtx-Start) is determined by [(SFN×10)+subframe number] modulo (cell DTX/DRX cycle)=cell DTX/DRX slot offset. Wherein the cell DTX/DRX on duration/cycle is started from the SFN. The offset to modify the UE DRX start offset or slot offset is determined by (SFN+offset) mod T=0, wherein Tis UE DRX on duration or UE DRX cycle or cell DTX/DRX on duration. In some embodiments, the new UE DRX start offset or slot offset is determined by a function of the offset and the original UE DRX start offset or slot offset. Wherein the original UE DRX start offset or slot offset is the UE DRX start offset or slot offset in the last recent UE DRX cycle or the UE DRX start offset or slot offset configured by RRC signaling. Wherein the function includes addition, and/or multiplication, and/or subtraction, and/or division and/or XOR, and/or modulo.

For example, the start slot/symbol/time of UE DRX on duration timer/cycle during a cell DTX/DRX on duration is further determined by at least one of UE ID, the number of cell DTX/DRX on duration in a time duration (e.g. a cell DTX/DRX cycle or UE DRX cycle or UE DRX on duration) (NO), the number of UE DRX on duration during a cell DTX/DRX on duration (N1), an index of one or a group of start time of UE DRX on duration timer in a UE DRX on duration (i0), the index of (occasion of) the UE DRX on duration in a cell DTX/DRX on duration (i1), an indication of the number of availability of the start time of UE DRX on duration timer (N3), an index of one or a group of start time of cell DTX/DRX on duration in a UE DRX on duration (i2), or the index of the cell DTX/DRX on duration in a cell DTX/DRX on duration (i2). For example, the index of the start slot/symbol/time of UE DRX on duration timer/cycle=((UEID modN1)*N2+i2) mod N. The UE determines the new slot offset of the UE DRX on duration timer based on the index of the start slot/symbol/time of UE DRX on duration timer/cycle. The UE starts the UE DRX on duration timer after the new slot offset from the beginning of the SFN. Wherein the SFN is the subframe number that cell DTX/DRX on duration/cycle starts.

In some embodiments, the cell DTX/DRX may be regarded as least one of the cell DTX and/or the cell DRX and/or alignment of cell DTX/DRX and UE DRX for one or more base stations (BSs).

In some embodiments, the cell DTX/DRX off duration includes at least one of the cell DTX/DRX non active period, cell DTX/DRX outside-active-time, outside of cell DTX/DRX active time, outside of cell DTX/DRX on duration in a cell DTX/DRX periodicity/cycle and outside UE DRX Active Time.

In the following paragraphs, many aspects of the cell DTX/DRX are disclosed below.

In some embodiments, when the cell DTX/DRX is configured in a serving cell of a UE, a cell DTX/DRX active time for the serving cell includes at least one of the following:
an active time of the UE DRX for the UE; or
a duration when a timer is running during a cell DTX/DRX cycle; wherein the timer is configured with the cell DTX/DRX; or
a duration when a timer is running during a cell DTX/DRX cycle that is related to HARQ-ACK (hybrid automatic repeat request acknowledgment) information and/or a RACH procedure (random access channel); wherein the timer is configured with the cell DTX/DRX; wherein in some embodiments, the timer configured with cell DTX/DRX comprises at least timer configured with UE CDRX, a timer of cell DTX/DRX on duration, a timer of cell DTX/DRX for data reception/transmission, a timer of cell DTX/DRX for data retransmission/repetition, a timer of cell DTX/DRX active time, a timer of cell DTX/DRX activation/enabling, a timer of cell DTX/DRX deactivation/disabling, a timer of cell DTX/DRX cycle or a timer of cell DTX/DRX; or
a duration after the UE reports HARQ-ACK information for a data transmission; or
a duration after the UE reports a NACK (negative acknowledgment) for a data transmission; or
a time duration that starts after the UE reports a NACK for a data transmission and/or ends after the UE receives the data successfully; or
a timer related to a data retransmission which is running during a cell DTX/DRX cycle; or
a timer drx-onDurationTimer or a timer drx-InactivityTimer is running; or
a timer drx-RetransmissionTimerDL, a timer drx-RetransmissionTimerUL or a timer drx-RetransmissionTimerSL is running; or
a duration when the UE is performing a Scheduling Request procedure; or
a Scheduling Request is sent on PUCCH (physical uplink control channel) and/or a Scheduling Request is pending, wherein if this Serving Cell is part of a non-terrestrial network, the Active Time is started after the Scheduling Request transmission that is performed when the SR_COUNTER is O for all the SR (Scheduling Request) configurations with pending SR(s) plus the UE-gNB RTT (round trip time); or
the UE is in a time window to monitor an RAR (Random Access Response) and/or receive a MsgB; or
a timer ra-ContentionResolutionTimer or msgB-Response Window is running; or
a PDCCH indicating a new transmission addressed to the C-RNTI (Cell Radio Network Temporary Identifier) of the MAC (Medium Access Control) entity has not been received after a successful reception of a RAR for the Random Access Preamble not selected by the MAC entity among the contention-based Random Access Preamble; or
the cell DTX/DRX on-duration is continuing; or
a second cell DTX/DRX duration is continuing; or
DCI carrying an indication related to a cell DTX/DRX activation or a cell DTX/DRX configuration set is detected and/or the UE applies the indication; or
the UE is performing a RACH procedure during a cell DTX/DRX cycle; or
the UE is waiting for receiving or transmitting a transport block associated with a retransmission; or
a time duration of cell DTX/DRX cycle overlapped with UE CDRX on duration, and/or the start of UE CDRX on duration timer is indicated by wake-up indication in DCI format 2-6; or
a time duration of cell DTX/DRX cycle overlapped with UE CDRX active time; or
a time duration of cell DTX/DRX on duration overlapped with UE CDRX active time; or
a time duration of cell DTX/DRX off duration overlapped with UE CDRX active time.

In some embodiments, a second cell DTX/DRX duration includes at least one of:
a duration to receive a PDSCH for retransmission; or
a time duration after the end of cell DTX/DRX on duration; or
a time duration after the detection of a first or a second PDCCH; or
a time duration after the detection of a PDCCH scheduling a PDSCH or PUSCH; or
a time duration after a PDSCH reception or a PUSCH transmission; or
a time duration before the start of a next cell DTX/DRX cycle; or
a time duration before the end of a consecutive duration of UE CDRX active time.

In some embodiments, the cell DTX/DRX off duration includes at least outside cell DTX/DRX active time, outside of cell DTX/DRX active time, cell DTX/DRX outside-active-time, outside of cell DTX/DRX on duration, or cell DTX/DRX non active periods.

In some embodiments, in the cell DTX/DRX active time, the UE may:
perform UE behaviors specified during an Active Time of the UE DRX for the UE; or
monitor a first PDCCH and/or a second PDCCH; wherein the CRC of the first PDCCH and/or a second PDCCH is scrambled by a Cell Radio Network Temporary Identifier, C-RNTI, a Cancellation Indication RNTI, CI-RNTI, a Configured Scheduling RNTI, CS-RNTI, an Interruption RNTI, INT-RNTI, a Slot Format Indication RNTI, SFI-RNTI, a Semi-Persistent CSI RNTI, SP-CSI-RNTI, a Transmit Power Control-PUCCH-RNTI, TPC-PUCCH-RNTI, a Transmit Power Control-PUSCH-RNTI, TPC-PUSCH-RNTI, a Transmit Power Control-Sounding Reference Symbols-RNTI, TPC-SRS-RNTI, an Availability Indication RNTI, AI-RNTI, a Sidelink RNTI, SL-RNTI, a Sidelink Configured Scheduling RNTI, SLCS-RNTI or a Sidelink Semi-Persistent Scheduling Vehicle RNTI, V-RNTI; or
monitor a first PDCCH and/or a second PDCCH; wherein the first PDCCH carries a DCI with a DCI format 0-1 and/or DCI format 1-1, and/or DCI format 0-2, and/or DCI format 1-2, and/or DCI format 2-6 on the Serving Cells; or
monitor a first PDCCH and/or a second PDCCH on a SCell (secondary cell) and/or monitor a first PDCCH and/or a second PDCCH for a SCell; or
monitor a RAR or receive a MsgB during a time window; or
perform the ongoing RA (random access) procedure; or
start or restart or keep a first timer running, in which the first timer includes at least one of the followings: timer related to search space set group 1 (SSSG1) or search space set group 1 (SSSG2) for the PDCCH monitoring adaptation, or skipping a duration for the PDCCH monitoring adaptation, or a bwp-InactivityTimer, or a drx-onDurationTimer, or a drx-InactivityTimer, or a drx-RetransmissionTimerDL, or a drx-RetransmissionTimerUL, or a drx-ShortCycleTimer, or a drx-HARQ-RTT-TimerDL, or a drx-HARQ-RTT-TimerUL, or a drx-HARQ-RTT-TimerSL, or a HARQ-RTT-TimerDL-NTN, or a HARQ-RTT-TimerUL-NTN, or drx-RetransmissionTimerUL, or a drx-Retransmission TimerDL, or a drx-RetransmissionTimerSL, or a drx-RetransmissionTimerDL-PTM, or the timer configured with cell DTX/DRX; In some embodiments, the timer configured with cell DTX/DRX comprises at least timer configured with UE CDRX, a timer of cell DTX/DRX on duration, a timer of cell DTX/DRX for data reception/transmission, a timer of cell DTX/DRX for data retransmission/repetition, a timer of cell DTX/DRX active time, a timer of cell DTX/DRX activation/enabling, a timer of cell DTX/DRX deactivation/disabling, a timer of cell DTX/DRX cycle or a timer of cell DTX/DRX; or
start or restart or keep performing a first PDCCH monitoring during a first timer is running; or
perform UE behaviors during a UE CDRX active time during a time duration; Wherein the time duration comprises at least one of:
   a) a time duration of a cell DTX/DRX cycle overlapped with a UE CDRX (Connected Mode Discontinuous Reception) on-duration, and/or the start of the UE CDRX on-duration timer is indicated by a wake-up indication in DCI format 2-6; or
   b) a time duration of a cell DTX/DRX cycle overlapped with a UE CDRX active time; or
   c) a time duration of a cell DTX/DRX on-duration overlapped with a UE CDRX active time; or
   d) a time duration of a cell DTX/DRX off-duration overlapped with a UE CDRX active time; or
      an SRS (Sounding Reference Signal) transmission; or
      receive a common and broad channel/signal;
      or perform CSI measurement; or
      perform CSI (channel status information) reporting; or
      a PUCCH (physical uplink control channel) transmission and/or PUSCH reception and/or PDSCH (physical downlink shared channel) reception.

In some embodiments, when the cell DTX/DRX is configured, the cell DTX/DRX outside-active-time for a serving cell includes at least one of:
the cell DTX/DRX off-duration; or
the time duration that is not during the cell DTX/DRX active time;
or the time duration that is not during UE DRX active time; or
outside UE DRX active time.

In some embodiments, during the outside cell DTX/DRX active time, the UE may:
not transmit an SRS; or
not report CSI; or
not transmit on UL-SCH; or
not transmit on RACH; or
not monitor a first PDCCH; or
not monitor a first PDCCH on a SCell and/or not monitor a first PDCCH for a SCell; or
not transmit a PUCCH; or
not receive a DL-SCH (downlink shared channel); or
cancel the ongoing Random Access procedure; or
stop running of a first timer; or
receive a semi-persistent scheduling, SPS, physical downlink shared channel, PDSCH, reception; or
transmit a configured grant, physical uplink shared channel, PUSCH.

In some embodiments, the UE monitors a PDCCH carrying scheduling information for the DL during the cell DTX on-duration, active time, or cycle. In some embodiments, the UE monitors the PDCCH carrying scheduling information for the UL during the cell DRX on-duration, active time, or cycle.

In some embodiments, when the UE is configured with the cell DTX, the cell DTX functionality controls a first UE behavior according to certain requirements, and/or the base station (BS) may perform a first BS behavior according to the certain requirements.

In some embodiments, the first UE behavior includes a measurement based on a reference signal (RS) or common signals/channels, a first PDCCH (physical downlink control channel) monitoring, an SPS (semi-persistent scheduling) PDSCH (physical downlink shared channel) reception, and/or a PDSCH reception, and/or the reception associated with a RACH procedure.

In some embodiments, the RS includes a periodic CSI-RS, and/or a semi-persistent CSI-RS, and/or an aperiodic CSI-RS, and/or remote interference management RS (RIM-RS), and/or positioning RS (PRS), and/or SS/PBCH block, and/or phase-tracking RS (PT-RS), and/or secondary synchronization signal (SSS), and/or primary synchronization signal (PSS).

In some embodiments, the first PDCCH monitoring includes monitoring a first PDCCH that is the PDCCH carrying DL scheduling information, and/or is the PDCCH carrying at least one of a DCI format 1-0, DCI format 1-1, DCI format 1-2, DCI format 2-0, DCI format 2-1, DCI format 2-2, DCI format 2-3, DCI format 2-4, DCI format 2-5, DCI format 2-6, and/or DCI format 2-7.

In some embodiments, the certain requirements include at least one of the followings:
the UE is in a cell DTX active time;
the UE is in a cell DTX on-duration;
the UE is in a cell DTX cycle; or
the UE is in the duration of a cell DTX on-duration or active time overlapped with a UE DRX on-duration or active time; or
the UE reports a NACK of HARQ-ACK information for PDSCH reception; or
the UE detects a PDCCH with scheduling information for a data retransmission; or
the UE sends a SR; or
the UE performs RACH procedure.

In some embodiments, the first BS behavior includes common signal/channels or RS transmission and/or the PDCCH or PDSCH transmission and/or the transmission associated with the RACH procedure.

In some embodiments, the UE performs DL reception associated with a first UE behavior or BS performs DL transmission associated with a first BS behavior during the cell DTX active time or the cell DTX on-duration. Wherein the UE stops performing DL reception associated with a first UE behavior or BS stops performing DL transmission associated with a first BS behavior during outside of the cell DTX active time (also refer to as the cell DTX outside-active-time) or the cell DTX on-duration.

In accordance with an embodiment of the invention, when the UE is configured with the cell DRX, cell DRX functionality controls a second UE behavior according to certain requirements (see below some example requirements), and/or the base station (BS) may perform a second BS behavior according to the certain requirements.

In some embodiments, the second UE behavior includes SRS transmission, and/or a second PDCCH monitoring, and/or SR (scheduling request) transmission, and/or CG-PUSCH transmission (Configured grant-PUSCH), and/or PUCCH/PUSCH transmission, and/or the transmission associated with RACH procedure.

In some embodiments, the second PDCCH monitoring is monitoring a second PDCCH that the PDCCH carrying UL scheduling information, and/or is the PDCCH carrying at least one of DCI format 0-0, DCI format 0-1, DCI format 0-2, DCI format 2-0, DCI format 2-1, DCI format 2-2, DCI format 2-3, DCI format 2-4, DCI format 2-5, DCI format 2-6, and/or DCI format 2-7.

In some embodiments, the certain requirements include at least one of the following: the UE is in the cell DRX active time; the UE is in the cell DRX on-duration; the UE is in the cell DRX cycle; the UE is in the duration of the cell DRX on-duration or active time overlapped with the UE DRX on-duration or active time; the UE reports a NACK of HARQ-ACK information for PDSCH reception; the UE detects a PDCCH with scheduling information for a data retransmission; the UE sends a SR; or the UE performs RACH procedure.

In some embodiments, the second BS behavior includes the reception for a report of HARQ-ACK feedback or the measurement result of RSRP/RSRQ/RSSVCQI, SRS, PUCCH/PUSCH, or the transmission associated with RACH procedure.

In some embodiments, the UE performs UL transmission associated with a second UE behavior or the BS performs UL reception associated with a second BS behavior during the cell DRX active time or the cell DRX on-duration. In some embodiments, the UE stops UL transmission associated with a second UE behavior or the BS stops UL reception associated with a second BS behavior during outside of the cell DRX active time (also refer to as the cell DRX outside-active-time) or the cell DRX on-duration.

In accordance with an embodiment of the invention, when UE is configured with the cell DTX or the cell DRX, the cell DTX/DRX controls a third UE behavior according to certain requirements.

In some embodiments, the third UE behavior comprises UE behavior in the UE DRX Active Time or a timer behavior or a first UE behavior or a second UE behavior.

In some embodiments, the UE performs a third UE behavior during the cell DTX/DRX active time and/or the cell DTX/DRX on-duration and/or Active Time of the UE DRX.

In some embodiments, the UE stops UL transmission associated with a second UE behavior or BS stops UL reception associated with a second BS behavior during outside of the cell DRX active time or the cell DRX on-duration. In some embodiments, the UE stops DL transmission associated with a first UE behavior or BS stops DL reception associated with a first BS behavior during a duration outside of the cell DTX active time or the cell DTX on-duration. In some embodiments, the timer behavior is the start or restart or running or stopping of the timer configured with the UE DRX or timer configured with cell DTX/DRX.

In some embodiments, the cell DTX/DRX functionality does not control the timer behavior.

In some embodiments, the cell DTX/DRX functionality may control the third UE behavior associated with timer behavior.

In some embodiments, the cell DTX configuration information is associated with search space set configuration for DL data transmission and/or UE behaviors associated with the DL procedure. In some embodiments, the search space set configuration may include PDCCH monitoring occasions for the detection of DCI format 1-0 and/or DCI format 1-1 and/or DCI format 1-2 and/or DCI format 3-1 and/or DCI format 2-0 and/or DCI format 2-1 and/or DCI format 2-2 and/or DCI format 2-3 and/or DCI format 2-4 and/or DCI format 2-5 and/or DCI format 2-6 and/or DCI format 2-7.

In some embodiments, the cell DRX configuration information is associated with search space set configuration for UL data transmission and/or UE behaviors associated with UL procedure. In some embodiments, the search space set configuration may include PDCCH monitoring occasions for the detection of DCI format 0-0 and/or DCI format 0-1 and/or DCI format 0-2 and/or DCI format 3-0 and/or DCI format 2-0 and/or DCI format 2-1 and/or DCI format 2-2 and/or DCI format 2-3 and/or DCI format 2-4 and/or DCI format 2-5 and/or DCI format 2-6 and/or DCI format 2-7.

In some embodiments, the search space set configuration may include DE-specific search space set and/or Type3-common search space set.

In accordance with an embodiment of the invention, the UE behavior(s) defined in the cell DTX/DRX on-duration or off period is/are not changing by any of timers related to the UE DRX operations.

In accordance with an embodiment of the invention, the cell DTX/DRX disclosed above is used for the RRC connected mode UE.

In accordance with an embodiment of the invention, the UE DRX disclosed above being used for the RRC connected mode UE and/or being CDRX functionality.

In accordance with an embodiment of the invention, the cell DTX/DRX off-duration or the cell DTX/DRX outside-active-time include the time duration that is not during the cell DTX/DRX active time or the cell DTX/DRX on-duration.

In accordance with an embodiment of the invention, the cell DTX/DRX on-duration is being configured as a cell DTX/DRX on-duration timer.

In accordance with an embodiment of the invention, the cell DTX/DRX inactivity timer is configured by RRC signaling, which is started or restarted when a PDCCH with data scheduling information is detected by a UE, or a HARQ-ACK information is fed back by a UE, or a cell DTX/DRX on-duration timer is stopped, or a RACH procedure or SR procedure is occurred/ongoing, or a DCI indicating an information triggering the start or restart of the cell DTX/DRX inactivity timer.

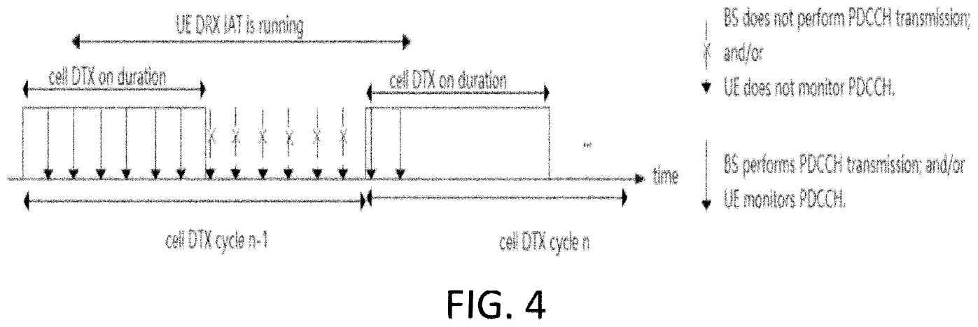

FIG. 4 illustrates an example in that the cell DTX/DRX is relevant to the third UE behavior when the timer is running but does not control the timer behavior in accordance with an embodiment of the invention. In this example, the UE does not monitor PDCCH during the UE DRX Inactivity timer (IAT) running if BS and/or the UE is in the cell DTX off-duration.

In some embodiments, both the cell DTX cycle and the DRX cycle have the same definition and represent the duration for periodic the cell DTX/DRX or one or more cycles for DTX/DRX operation.

In some embodiments, the cycle of the cell DTX/DRX or the UE DRX is the periodicity or a time period for the cell DTX/DRX or the UE DRX.

In some embodiments, higher layer parameter represents the MAC CE and/or RRC signaling.

In some embodiments, the cell DTX/DRX represents the cell DTX and the cell DRX, and/or the cell DTX, and/or the cell DRX, and/or alignment of cell DTX/DRX and UE DRX.

In some embodiments, the base station (BS) may mean a communication node, or BTS (Base Transceiver Station) in 2G, or NodeB in 3G, or eNB (E-UTRAN NodeB/enhanced NodeB) in 4G, or gNB in 5G, or a base station of LTE (Long term evolution) or NR (New Radio access technology), or a base station of further generation communication system, or a cell with a normal state or activated state or deactivated state or dormant state, or a cell providing basic coverage, or a cell boosting capacity, or a small cell, or a primary cell, or a secondary cell.

In accordance with an embodiment of the invention, the cell DTX/DRX configuration information (also referred to as configuration information for the cell DTX/DRX) and UE behaviors are disclosed as follows.

In accordance with an embodiment of the invention, UE determines a cell DTX/DRX pattern according to one or more cell DTX configuration information.

### Configuration Information for the Cell DTX/DRX

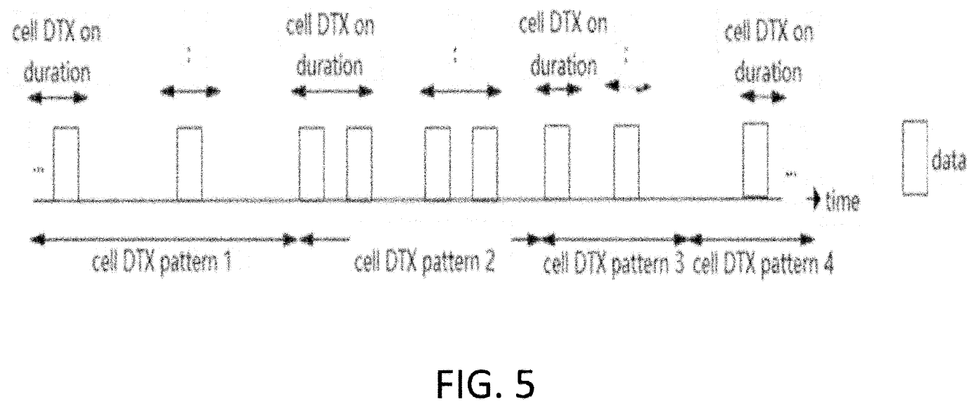

In accordance with an embodiment of the invention, the configuration information for the cell DTX/DRX includes at least one of the following:
an indication to enable/disable the cell DTX/DRX functionality for a time duration. In some embodiments, the enable/disable the cell DTX/DRX functionality for a time duration includes that the UE activates/deactivates the cell DTX/DRX function or performs or stops the cell DTX/DRX for a time duration. In some embodiments, the enable/disable the cell DTX/DRX functionality for a time duration includes that the UE assumes that the cell DTX/DRX function is valid/invalid or available/unavailable for a time duration. In some embodiments, the time duration includes one or more of the cell DTX/DRX cycle, or the time duration is smaller than a cell DTX/DRX cycle, or the time duration is one or more the cell DTX/DRX on-duration, or the time duration is configured by higher layer parameter. In some embodiments, the enable/disable the cell DTX/DRX functionality for a time duration includes activating/deactivating cell DTX/DRX operation according to a cell DTX/DRX pattern or a cell DTX/DRX periodicity/cycle or activating/deactivating cell DTX/DRX functionality for a time duration.
an indication to enable/disable one or multiple the cell DTX/DRX cycles. In some embodiments, the configuration information includes starting or not starting one or multiple of the cell DTX/DRX cycles, or activating/deactivating a configuration information of one or multiple of the cell DTX/DRX cycles, or activating/deactivating the cell DTX/DRX for one or multiple of the cell DTX/DRX cycles.
an indication to enable/disable one or multiple of the cell DTX/DRX on-durations. In some embodiments, the configuration information includes starting or not starting one or multiple of the cell DTX/DRX on-duration, or activating/deactivating a configuration information of one or multiple of the cell DTX/DRX on-durations, or activating/deactivating the cell DTX/DRX for one or multiple of the cell DTX/DRX on-durations.
the availability of a cell DTX/DRX cycle. In some embodiments, the configuration information includes activating a configuration information of a cell DTX/DRX cycle, or assuming that the cell DTX/DRX is available for a cell DTX/DRX cycle.
the start of the cell DTX/DRX cycle. In some embodiments, the configuration information is used to determine the start of the cell DTX/DRX cycle.
the cycle of the cell DTX/DRX. In some embodiments, the configuration information is used to determine the time period or periodicity of a cell DTX/DRX cycle. In some embodiments, the cell DTX/DRX cycle is periodic.
the cell DTX/DRX on-duration of the cell DTX/DRX cycle. In some embodiments, the configuration information is used to determine the time duration of the cell DTX/DRX on-duration during a cell DTX/DRX cycle. In some embodiments, the indication information indicates a number of symbols/slots during a time duration and/or all zeros symbols/slots during a time duration as cell DTX/DRX on-duration. Wherein a time duration is one or more mini slot or slot or subframe or frame or millisecond.
the long cell DTX/DRX cycle. In some embodiments, the configuration information is used to determine the time duration of a long the cell DTX/DRX cycle.
short cell DTX/DRX cycle. In some embodiments, the configuration information is used to determine the time duration of a short the cell DTX/DRX cycle. In some embodiments, a short the cell DTX/DRX cycle is configured together with a long the cell DTX/DRX cycle. In some embodiments, a short cell DTX/DRX cycle timer is used to determine the duration the UE may follow the short cell DTX/DRX cycle.
one or multiple DTX/DRX patterns. In some embodiments, UE can be indicated to select a cell DTX/DRX pattern among multiple cell DTX/DRX patterns. In some embodiments, the cell DTX/DRX pattern includes a normal mode without cell DTX/DRX pattern. FIG. 5 shows an example that UE perform UE behavior according to a cell DTX/DRX pattern selected from multiple cell DTX patterns.
enable/disable signal transmission and/or reception. In more detail:
   a. the configuration information may include a flag to enable/disable the signal transmission and/or reception; and/or
   b. when the configuration information of “enable/disable signal transmission and/or reception” is configured, the signal transmission and/or reception may be enabled, or the signal may be transmitted and/or received. If the configuration information of “enable/disable signal transmission and/or reception” is not configured, the signal transmission and/or reception may not be enabled or disabled, or the signal may not be transmitted and/or received.
   c. the signal includes reference signals (e.g., SRS, CSI-RS, etc.), UCI, PUCCH, SR, and/or PDCCH, PDSCH and PUSCH. In some embodiments, the PDSCH includes semi-persistent PDSCH. The PUSCH includes type 1 configured grant PUSCH or type 2 configured grant PUSCH. In some embodiments, the signal is used to indicate whether to perform periodic CSI and/or semi-persistent CSI or not. In some embodiments, the signal is used to indicate whether to transmit/receive data scheduling for retransmission or not. In some embodiments, the signal is a signal related to the UL and/or DL procedures. In some embodiments, the signal is transmitted and/or received during the cell DTX/DRX on-duration, the cell DTX/DRX active time, the cell DTX/DRX cycle and/or the cell DTX/DRX off-duration, the cell DTX/DRX outside-active-time and/or during a duration that is not the cell DTX/DRX on-duration, the cell DTX/DRX active time and/or the cell DTX/DRX cycle.
   d. Wherein this configuration information is applied for the cell DTX/DRX on-duration, the cell DTX/DRX active time, the cell DTX/DRX cycle and/or the cell DTX/DRX off-duration, the cell DTX/DRX outside-active-time.
   e. The content/interpretation of this configuration information is related to the type of reference signal, the type of link direction for signal (e.g., uplink and downlink), the type of signaling to indicate this configuration information (e.g., L1 signaling, MAC CE, and RRC signaling). In some embodiments, the content/interpretation is different from the type of signals. For example, if the signal transmission and/or reception is configured by RRC signaling, this configuration information includes whether the signal may be transmitted and/or received or not, and/or where the signal may be transmitted and/or received.
   f. In some embodiments, whether to enable/disable signal transmission and/or reception is determined by the traffic characteristic. In some embodiments, the traffic characteristic includes at least one of the traffic type, the kind of service and applications, PDB, mean arrival time-interval, packet size, periodic feature, transmission mode or 5QI. For example, when extended reality, XR, traffic is supported by the UE, the CSI report and/or SRS transmission are enabled in cell DTX/DRX non active period.
   g. In some embodiments, whether to enable/disable signal transmission and/or reception is determined by a threshold. In some embodiments, the threshold is related to the traffic characteristic. In some embodiments, the traffic characteristic includes at least one of the traffic type, the kind of service and applications, PDB, mean arrival time-interval, packet size, periodic feature, transmission mode or 5QI. For example, when the PDB for a traffic model is smaller than a threshold and the CSI report and/or SRS transmission are enabled in cell DTX/DRX non active period. Wherein the threshold of PDB is a positive number and is not larger than 100 ms.
offset. For example, the offset is:
   a. the start offset that is used to determine the start of the cell DTX/DRX cycle, and/or
   b. wherein the offset is used to determine the start of the cell DTX on-duration, or the cell DTX active time, or the cell DRX cycle, or the cell DRX on-duration, or the cell DRX active time, and/or
   c. wherein the offset may include the length of time interval between the start of the cell DTX cycle and the cell DRX cycle, or the interval between the start of the cell DTX on-duration and the cell DRX on-duration.
   d. wherein the offset is used to determine the start offset of the UE DRX on duration or UE DRX cycle; In some embodiments, the offset is a minimum gap between two adjacent start positions of UE DRX on duration/cycle for the UEs in a cell or a cell group. In some embodiments, the offset is used to modify the value of start offset of the UE DRX on duration/cycle. In some embodiments, the candidate values of offset are configured by higher layer parameter.

In some embodiments, an offset, that is the minimum length of time interval between the start position of the cell DTX cycle and the cell DRX cycle or between the start position of the cell DTX on-duration and the cell DRX on-duration, can be configured by higher layer parameter.

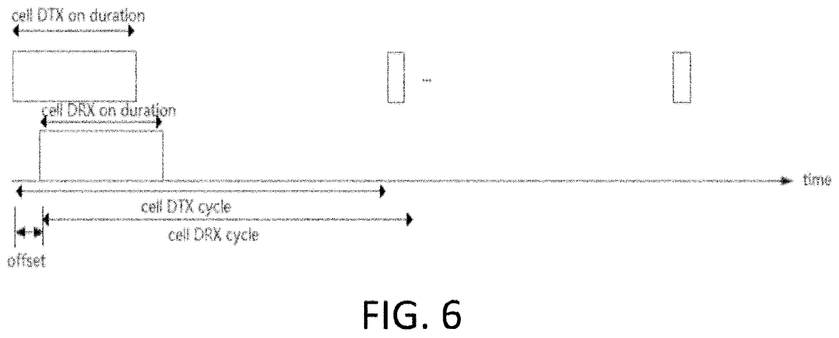

FIG. 6 illustrates an example of an offset between the start of the cell DTX on-duration/the cell DTX cycle and the cell DRX on-duration/the cell DRX cycle according to an embodiment of the present disclosure.

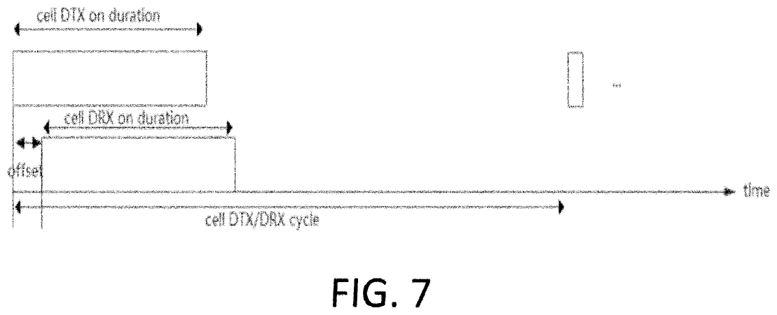

FIG. 7 illustrates an example of an offset between the start of the cell DTX on and the cell DRX on-duration within the same cell DTX/DRX cycle according to an embodiment of the present disclosure.

In some embodiments, the offset is used to determine the start position of the cell DTX cycle or the cell DRX cycle.

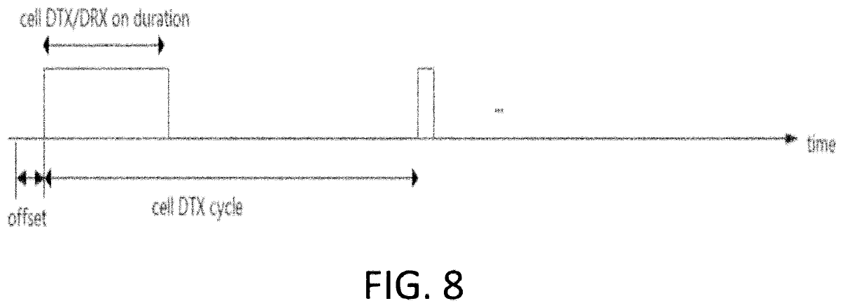

FIG. 8 illustrates an example of an offset used to determine the start of the cell DTX cycle, or the start of the cell DTX/DRX on-duration according to an embodiment of the present disclosure.
the cell DTX activation and/or deactivation. Details of the cell DTX activation and/or deactivation can be ascertained by referring to the descriptions about an indication to enable/disable the cell DTX/DRX functionality for a time duration, an indication to enable/disable one or multiple the cell DTX/DRX cycles, an indication to enable/disable one or multiple the cell DTX/DRX on-durations, and the availability of a cell DTX/DRX cycle described above.
the cell DRX activation and/or deactivation. Details of the cell DRX activation and/or deactivation can be ascertained by referring to the descriptions about an indication to enable/disable the cell DTX/DRX functionality for a time duration, an indication to enable/disable one or multiple the cell DTX/DRX cycles, an indication to enable/disable one or multiple the cell DTX/DRX on-durations, and the availability of a cell DTX/DRX cycle described above.
the starting position of the cell DTX/DRX configuration information in a L1 signaling. In some embodiments, the L1 signaling is DCI format 2-6 or DCI format 0-1 or 0-2 or 1-1 or 1-2 or a new DCI format for a group of UEs.
the cell DTX and/or the cell DRX activation/deactivation for a group of cells.
a set of candidate values of at least one of the above configuration information.
one or multiple configuration sets for the cell DTX/DRX. In some embodiments, the configuration information of “one or multiple configuration sets for the cell DTX/DRX” includes at least one of the above cell DTX/DRX configuration information and/or set indexes/identities/identifiers of one or multiple configuration sets.

In some embodiments, the configuration set for the cell DTX and/or the cell DRX include at least one of the following parameters: set ID, offset, start offset, the cell DTX and/or the cell DRX cycle, the cell DTX and/or the cell DRX on-duration, the cell DTX and/or the cell DRX off-duration, the cell DTX and/or the cell DRX inactivity timer. Wherein start offset includes at least one of the start offset for DTX/DRX cycle and/or the start offset for DTX/DRX on-duration.

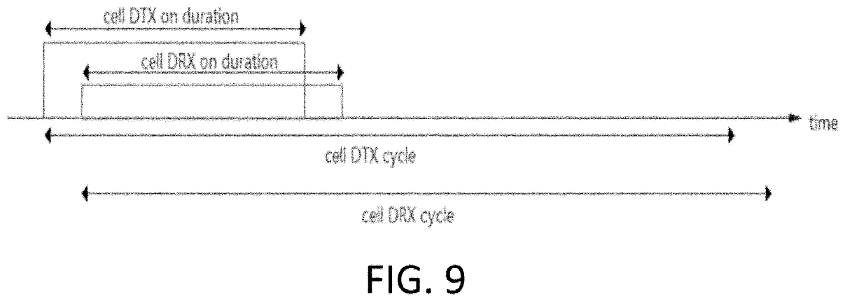

FIG. 9 shows an example where parameters of start offset, cycle and on-duration in the configuration sets for the cell DTX and the cell DRX are configured separately according to an embodiment of the present disclosure.

In some embodiments, the candidate values of at least one of the parameters in the configuration set(s) for the cell DTX and the cell DRX are the same.

In some embodiments, the candidate values of at least one of the parameters in the cell DTX configuration set and the cell DRX configuration set are the same.

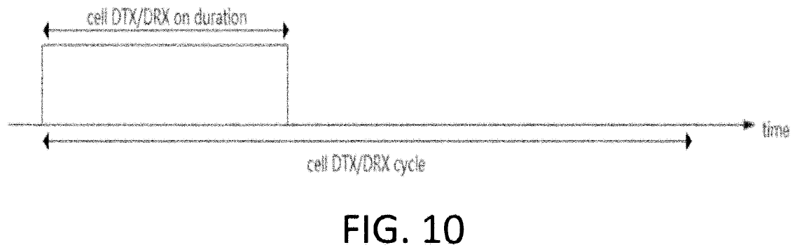

FIG. 10 shows an example where parameters of cycle, start offset and on-duration in the configuration sets for the cell DTX and the cell DRX are configured as the same value according to an embodiment of the present disclosure.

In some embodiments, the parameters of configuration set for the cell DTX includes at least one of the parameters of the configuration for the cell DRX, and vice versa.

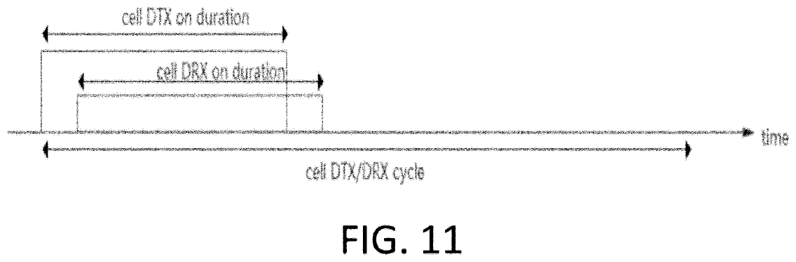

FIG. 11 shows an example where parameters of cycle and the start offset of the cycle in the configuration sets for the cell DTX are used for the cell DRX according to an embodiment of the present disclosure.

In some embodiments, at least one of the parameters of the configuration set for the cell DTX/DRX are used for both the cell DTX and the cell DRX. In some embodiments, the at least one of the parameters include start offset, and/or a cycle for the cell DTX/DRX, and/or on-duration for the cell DTX/DRX.

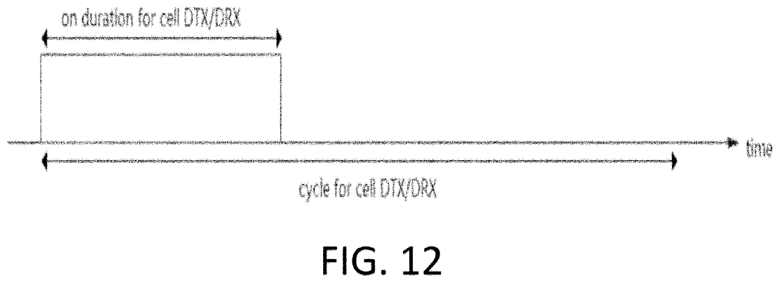

FIG. 12 shows an example where parameters of start offset, on-duration and cycle in the configuration sets for the cell DTX and the cell DRX are used for both the cell DTX and the cell DRX.

In some embodiments, the cell DTX configuration information is associated with search space set configuration for DL data reception and/or UE behaviors associated with DL procedure. For example, a set ID of the cell DTX configuration information may be associated with a search space set configuration for monitoring PDCCH scheduling DL data.

In some embodiments, the cell DTX/DRX indication information further includes at least one of the followings:
a number of cell DTX/DRX on duration in a time duration. The indication information indicates the number of cell DTX/DRX on duration in a cell DTX/DRX cycle or UE DRX cycle or UE DRX on duration;
a number of occasions for UE DRX on duration in a timer duration. The indication information indicates the number of occasions for UE DRX on duration during a cell DTX/DRX on duration/cycle;
an index of one or a group of the start time of UE DRX on duration timer during occasions for UE DRX on duration. In some embodiments, there is one or more start time of UE DRX on duration timer during an occasion for UE DRX on duration. In some embodiments, the indication information indicates the index of the start time of UE DRX on duration timer during occasions for UE DRX on duration.
an index of (occasions of) the UE DRX on duration in a cell DTX/DRX on duration. In some embodiments, there are one or more UE DRX on durations during a cell DTX/DRX on duration.
an indication of the availability of UE DRX on duration timer. In some embodiments, there are a number of start time of the UE DRX on duration timer. The indication information indicates the number of the availability of UE DRX on duration timer during a time duration.
an indication of a number of availability of the start time of UE DRX on duration timer. In some embodiments, there are a number of available start time of the UE DRX on duration timer during a time duration. The indication information indicates the number of availability of the start time of UE DRX on duration timer during a time duration.
an index of one or a group of start time of cell DTX/DRX on duration during a time duration. In some embodiments, the time duration includes at least one of the UE DRX cycle, UE DRX on duration, UE DRX Active Time, cell DTX/DRX cycle, cell DTX/DRX on duration, or cell DTX/DRX off duration.
an index of one or a group of start time of cell DTX/DRX on duration during a time duration. In some embodiments, the time duration includes at least one of the UE DRX cycle, UE DRX on duration, UE DRX Active Time, cell DTX/DRX cycle, cell DTX/DRX on duration, or cell DTX/DRX off duration.
an index of the cell DTX/DRX on duration in a cell DTX/DRX on duration.

### Methods of Configuring/Indicating the Cell DTX/DRX

In accordance with an embodiment of the invention, the UE performs the cell DTX/DRX operations according to at least one of the following methods.

### Method 1:

In this method, one or multiple cell DTX configuration sets and/or one or multiple cell DTX configuration sets are provided by RRC signaling and/or the cell DTX/DRX Command MAC CE and/or a DCI.

The cell DTX configuration set with a set index/identifier and/or a parameter of the cell DTX configuration information is associated with a cell DRX configuration set with a set index/identifier and/or a parameter of the cell DRX configuration information, and vice versa.

Further, at least one of a cell DTX configuration set and a cell DRX configuration set is provided by RRC signaling and/or the cell DTX/DRX Command MAC CE and/or a DCI.

### Method 2:

In this method, the cell DTX/DRX configuration information IS provided by RRC signaling.

The UE is provided with the cell DTX/DRX configuration information. In some embodiments, the cell DTX/DRX configuration information includes one or more candidate values of parameters for the cell DTX/DRX, and/or one or more set(s) of the cell DTX/DRX configuration information.

### Method 3:

In this method, the cell DTX/DRX configuration information is configured by the cell DTX/DRX Command MAC CE.

The UE is configured by the cell DTX/DRX Command MAC CE.

In some embodiments, the cell DTX/DRX Command MAC CE IS used for DL transmission or UL reception.

In some embodiments, the DL transmission or UL reception is controlled by the cell DTX/DRX configuration. If the cell DTX/DRX Command MAC CE is received, one or more timers associated with the cell DTX/DRX is stopped or started or restarted, and/or the cell DTX/DRX is deactivated or activated, and/or the values of parameters for the cell DTX/DRX are changed, and/or the cell DTX/DRX cycle is deactivated or activated.

In some embodiments, the cell DTX/DRX cycle is at least one of the current cell DTX/DRX cycle, or the next cell DTX/DRX cycle, or the next n cell DTX/DRX cycle, or the one or more cell DTX/DRX cycle from the current or next cell DTX/DRX cycle to the cell DTX/DRX cycle before the cell DTX/DRX cycle activated by RRC and/or MAC CE and/or a DCI.

### Method 4:

In this method, the cell DTX/DRX configuration information is indicated by a DCI.

The UE is indicated by a DCI to perform the cell DTX/DRX operations according to the indication information related to the cell DTX/DRX.

In some embodiments, the cell DTX/DRX configuration information is one of sets of the cell DTX/DRX configuration information, and/or one of values of parameters in the set of the cell DTX/DRX configuration information, and/or one of candidate values of a parameter of the set of the cell DTX/DRX configuration information, and/or one of the UE DRX related parameters or DRX related RRC information element.

In some embodiments, the UE DRX related parameters or DRX related RRC information element include at least one of the periodicity and/or the offset of the UE long DRX cycle, the periodicity and/or the offset of the UE short DRX cycle, short DRX timer, the DRX on-duration timer, the DRX Inactivity timer, the DRX retransmission timer for DL and/or UL, and DRX HARQ-RTT-Timer for DL and/or UL.

### Method 5:

In this method, the cell DTX/DRX configuration information is indicated by SIB.

In some embodiments, the cell DTX/DRX configuration information is one or more set(s) or set ID(s) of the cell DTX/DRX configuration information, and/or one or more candidate values of one of more parameters of the cell DTX/DRX configuration information, and/or one or more parameters of the cell DTX/DRX configuration information.

In some embodiments, the cell DTX/DRX configuration information is indicated by SIB and/or a RRC signaling.

For example, the UE is indicated by SIB with a set of the cell DTX/DRX configuration information. The set of the cell DTX/DRX configuration information is one of the sets of DTX/DRX configuration information configured by RRC signaling.

In some embodiments, the cell DTX/DRX configuration information is indicated by SIB and/or a DCI and/or a RRC signaling.

In some embodiments, the cell DTX/DRX configuration information is indicated by SIB and/or a MAC CE and/or a RRC signaling. For example, the multiple cell DTX/DTX patterns are configured by RRC signaling and SIB indicates one of cell DTX/DRX pattern activation/deactivation or one of the candidate values of at least one of the cell DTX/DRX parameters. The MAC CE is used to indicate enable/disable cell DTX/DRX on duration/cycle/functionality.

For example, the UE may be indicated by SIB with a list of candidate values of one or more parameters of the cell DTX/DRX configuration information. The UE may be indicated by a DCI with one value of a list of candidate values of one or more parameters of the cell DTX/DRX configuration information.

For example, the UE may be provided with a number of sets of DTX/DRX configuration information. The UE may be indicated by the SIB with a list of candidate values of one or more parameters in a set of the cell DTX/DRX configuration information. The UE is indicated by a DCI with one value of a list of candidate values of one or more parameters of the cell DTX/DRX configuration information.

### Method 6:

In this method, one or more set(s) of the cell DTX/DRX configuration information is provided by RRC signaling, and one of set(s) of the cell DTX/DRX configuration information and/or one of values of parameters in the set of the cell DTX/DRX configuration information is indicated by DCI.

For example, the UE is provided with a set of candidate values of parameters for the cell DTX/DRX by RRC signaling. The UE detects a DCI indicating one of the candidate value(s) of one or more parameters for the cell DTX/DRX. UE performs the cell DTX/DRX operations according to the indication information indicated by DCI.

### Method 7:

In this method, one or more set(s) of the cell DTX/DRX configuration information is provided by RRC signaling, and/or one of parameters of the set of the cell DTX/DRX configuration information is indicated by the cell DTX/DRX Command MAC CE, and/or one of candidate values of one or more parameters related to the cell DTX/DRX is indicated by a DCI.

### Method 8:

In this method, a set of the cell DTX/DRX configuration information is provided by RRC signaling, and/or one or more parameters in the set of the cell DTX/DRX configuration information is indicated by the cell DTX/DRX Command MAC CE, and/or one value of one or more parameters related to the cell DTX/DRX is indicated by a DCI.

### Method 9:

In this method, at least one of the kinds of parameters and/or candidate values of the cell DTX/DRX configuration information configured for TDD are different from that for FDD.

For TDD, the configuration set of the cell DTX and the cell DRX is configured independently or separately. For FDD, the configuration set of the cell DTX and the cell DRX is configured by one RRC information element or MAC entity.

For TDD, the configuration set of the cell DTX and the cell DRX is configured with different values. For FDD, the configuration set of the cell DTX and the cell DRX is configured by one RRC information element or MAC entity.

### Method 10:

In this method, the UE is provided by the cell DTX/DRX. UE DRX related parameters or DRX related RRC information element are configured by RRC signaling and/or indicated by MAC CE and/or L1 signaling.

In some embodiments, the cell DTX/DRX and/or the UE DRX can be configured for a group of UEs together.

In some embodiments, the cell DTX/DRX and adaptation of DL common and broadcast signals can be configured for a group of UEs together.

In some embodiments, a UE configured with the cell DTX/DRX in a cell can be configured with one or more candidate values of the UE DRX parameters. In some embodiments, the UE DRX parameters include at least one of the following: DRX offset that is used to determine the start of DRX cycle; DRX on-duration timer; DRX inactivity timer; DRX cycle; DRX cycle includes long DRX cycle and/or short DRX cycle; DRX retransmission timer; DRX HARQ RTT timer. This can decrease the network congestion possibility when data transmissions for all of the UEs camping on the cell are scheduled on the same DRX on-duration.

In some embodiments, the parameters of the cell DTX/DRX are configured with the same values parameters of the UE DRX. In some embodiments, the parameters include at least one of the following: an offset that is used to determine the start of a UE DRX cycle and/or the cell DTX/DRX cycle; on-duration timer, e.g., the UE DRX on-duration timer, the cell DTX/DRX on-duration timer; inactivity timer, e.g., the UE DRX inactivity timer, the cell DTX/DRX inactivity timer; cycle, e.g., the UE DRX cycle, the cell DTX/DRX cycle; and/or a timer related to retransmission or HARQ-ACK report, e.g., the UE DRX retransmission timer, and/or the UE DRX HARQ RTT timer.

In some embodiments, one or more UE DRX parameters are configured as cell specific.

In some embodiments, the following design of configuration information is used to ensure the alignment of the cell DTX and the UE DRX. The same method can also be used for the alignment of the cell DRX and the UE DRX.

For example, the configuration information for the cell DTX and the UE DRX may include at least one of the following: offset; one or multiple configuration sets for the cell DTX and the UE DRX (wherein the configuration information of “one or multiple configuration set for the cell DTX and the UE DRX” includes at least one of the above parameters of the cell DTX and the UE DRX and/or set indexes/identities/identifiers of one or multiple configuration sets); and/or a set of candidate values of at least one of the parameters in the configuration set for the cell DTX and the UE DRX.

In some embodiments, the offset is: the start offset that is used to determine the start of the cell DTX cycle and the UE DRX cycle; and/or used to determine the start of the cell DTX on-duration, or the cell DTX active time, and/or the UE DRX cycle, or the UE DRX on-duration, or the UE DRX active time; and/or used to determine the length of time interval between the start of the cell DTX cycle and the UE DRX cycle, or the interval between the start of the cell DTX on-duration and the UE DRX on-duration, and/or the start offset of the UE DRX on duration or UE DRX cycle. In some embodiments, the offset is a minimum gap between two start positions of UE DRX on duration/cycle for the UEs in a cell or a cell group. In some embodiments, the offset is not larger than UE DRX on duration timer or cell DTX/DRX on duration or cell DTX/DRX on duration timer.

In some embodiments, the configuration set for the cell DTX and the UE DRX include at least one of the following parameters: set ID, start offset, the cell DTX cycle and/or the UE DRX cycle, the cell DTX on-duration and/or the UE DRX on-duration, the cell DTX off-duration and/or the UE DRX off-duration, the cell DTX inactivity timer and/or the UE DRX inactivity timer. Wherein start offset includes at least one of the start offset for the cell DTX cycle/the UE DRX cycle and/or the start offset for the cell DTX on-duration/the UE DRX on-duration.

In some embodiments, the configuration set for the cell DTX and the UE DRX include at least one of the candidate values of at least one of the parameters in the configuration sets for the cell DTX and the UE DRX

In some embodiments, the candidate values of at least one of the parameters in the configuration sets for the cell DTX and the UE DRX are the same.

In some embodiments, the candidate values of at least one of parameters in the cell DTX configuration set and the UE DRX configuration set are the same.

In some embodiments, the parameters of configuration set for the cell DTX includes at least one of the parameters of the configuration for the UE DRX, and vice versa.

In some embodiments, at least one of the parameters of the configuration set are used for both the cell DTX and the UE DRX. In some embodiments, the at least one of the parameters include: start offset, and/or a cycle for the cell DTX and/or the UE DRX, and/or on-duration for the cell DTX and/or the UE DRX.

### Values of Parameters of the Cell DTX/DRX Configuration Information

In accordance with an embodiment of the invention, the value(s) of the parameters for the cell DTX/DRX are related to the value(s) of the UE DRX parameters.

In some embodiments, at least one of parameters of the cell DTX/DRX are configured as the same values with the UE DRX parameters.

In some embodiments, the value of the cell DTX/DRX cycle or DTX/DRX on-duration or the cell DTX/DRX off-duration is configured as a multiple of the value of the UE DRX parameters, or the value of the UE DRX parameters is divisible by the value of the cell DTX/DRX cycle or DTX/DRX on-duration or the cell DTX/DRX off-duration.

In some embodiments, the value of cell DTX/DRX on duration timer or the length of cell DTX/DRX on duration is equal to the value of cell DTX/DRX periodicity or the cell DTX/DRX cycle.

In some embodiments, the value of cell DTX/DRX on duration timer or the length of cell DTX/DRX off duration is equal to the value of cell DTX/DRX periodicity or the cell DTX/DRX cycle.

In some embodiments, the value of the cell DTX/DRX cycle or DTX/DRX on-duration or the cell DTX/DRX off-duration is not smaller than 2 ms or is not larger than the product of n and 10240 ms, where n is an integer that is not smaller than 1.

In some embodiments, the value of the cell DTX/DRX cycle or DTX/DRX on-duration or the cell DTX/DRX off-duration is an integer in form of 8*zm, where 8 is at least one of the following: 1, 3, 5, 7, 15, and 35 and mis an integer that is not smaller than 0 and is not larger than 20. In some embodiments, the value of the cell DTX/DRX cycle or DTX/DRX on-duration or the cell DTX/DRX off-duration is in the unit of symbol or slot or millisecond. For example, the UE long DRX cycle is set to 60 ms, then the cell DTX/DRX cycle can be set to 120 ms, 180 ms or 300 ms, etc. For example, the UE long DRX cycle is set to 10240 ms, then the cell DTX/DRX cycle can be set to 5120 ms or 2048 ms that the UE long DRX cycle is divisible by the cell DTX/DRX cycle, or 20480 ms, 40960 ms or 51200 ms that is the multiple of the UE DRX cycle, etc.

In some embodiments, the value of the cell DTX/DRX cycle or DTX/DRX on-duration or the cell DTX/DRX off-duration is n in the unit of 1/32 millisecond, wherein n is a positive integer that is not larger than 31. For example, the value of the cell DTX/DRX cycle is 7 representing that the cell DTX/DRX cycle is 7/32 millisecond.

In some embodiments, the candidate value of the cell DTX/DRX cycle and/or the cell DTX/DRX on-duration and/or the cell DTX/DRX off-duration includes at least one of the candidate values of the UE long DRX cycle and/or the UE short DRX cycle. For example, the candidate value of the cell DTX/DRX cycle and/or the cell DTX/DRX on-duration and/or the cell DTX/DRX off-duration includes at least one of {2, 3, 4, 5, 6, 7, 8, 10, 14, 16, 20, 30, 32, 35, 40, 60, 64, 70, 80, 128, 160, 256, 320, 512, 640, 1024, 1280, 2048, 2560, 5120, 10240}; wherein the candidate values are in units of millisecond or slot.

In view of the above, it is possible to enable a suitable the cell DTX/DRX off-duration in order that the network achieves an energy saving benefit.

In some embodiments, the UE DRX parameters include at least one of the following: DRX on-duration timer; DRX inactivity timer; DRX HARQ RTT timer; DRX retransmission timer; DRX long cycle; DRX short cycle; the multiple of DRX short cycle and DRX short cycle timer; the start of search time for wake-up signal/DCI format 2-6; the search time for wake-up signal/DCI format 2-6.

In some embodiments, the start offset of the cell DTX/DRX cycle is related to or determined by at least one of the following UE DRX parameters: DRX long cycle or DRX short cycle; the offset of DRX long cycle or of DRX short cycle; the PS offset of the search time for DCI format 2-6.

In accordance with an embodiment of the invention, during a cell DTX/DRX cycle, different values of offset of DRX cycle or DRX on-duration timer or DRX inactivity timer are allowed for different group of cells, or for different cells or for different groups of UE or for different UEs.

In accordance with an embodiment of the invention, the values of parameters between the cell DTX and the cell DRX are the same. The parameters may include at least one of set ID, offset, start offset, the cell DTX and/or the cell DRX cycle, the cell DTX and/or the cell DRX on-duration, the cell DTX and/or the cell DRX off-duration, the cell DTX and/or the cell DRX inactivity timer.

In some embodiments, start offset includes at least one of the start offset for DTX/DRX cycle and/or the start offset for DTX/DRX on-duration.

In some embodiments, when the offset that is used to determine the length of time interval between the start of the cell DTX cycle and the cell DRX cycle, or the interval between the start of the cell DTX on-duration and the cell DRX on-duration, the value of offset is not larger than the length of the cell DTX on-duration and/or the length of the cell DRX on-duration length of the cell DTX cycle and/or the length of the cell DRX cycle.

In some embodiments, the candidate values of at least one of parameters m the configuration sets for the cell DTX and the cell DRX are the same.

In some embodiments, the candidate values of at least one of parameters in the cell DTX configuration set and the cell DRX configuration set are the same.

### UE Behavior(s)

This part relates to the UE behavior related to the cell DTX/DRX, the UE DRX and CSI report when the UE supports the UE feature of the cell DTX/DRX.

In accordance with an embodiment of the invention, if a UE is provided with the cell DTX/DRX configuration information, and/or the cell DTX/DRX configuration information between a first cell and a second cell satisfies a predefined condition, the UE may perform next action.

In some embodiments, the first cell is a primary cell and the second cell is a secondary cell; and/or the first cell is a secondary cell and the second cell is another secondary cell; and/or the first cell is a scheduling cell and the second cell is a scheduled cell; and/or the first cell and the second cell are the same cell; and/or the first cell is a PScell and the second cell is a secondary cell; and/or the first cell is a Pcell and the second cell is a PScell.

In some embodiments, the predefined condition is at least one of the following: at least one of the values of the cell DTX/DRX configuration information between a first cell and a second cell is different; the values of the cell DTX/DRX configuration information for first cell is smaller than that for second cell; the values of the cell DTX/DRX configuration information for first cell is larger than that for second cell; the values of the cell DTX/DRX configuration information for first cell is equal to that for second cell; the number of parameters related to the cell DTX/DRX for first cell is smaller than or larger than or equal to that for second cell; applying the cell DTX/DRX activation on a first cell and applying the cell DTX/DRX deactivation on a second cell; applying the cell DTX/DRX deactivation on a first cell and applying the cell DTX/DRX activation on a second cell; a first cell during the cell DTX/DRX on-duration/active time and a second cell during the cell DTX/DRX off-duration/outside-active-time; a first cell during the cell DTX/DRX off-duration/outside-active-time and a second cell during the cell DTX/DRX on-duration/active time; parameters of the cell DTX/DRX configuration information on a first cell is different from or is not aligned with parameters of the cell DTX/DRX configuration information.

In some embodiments, the next action is at least one of the following: the UE does not perform the cell DTX/DRX operations on a second cell according to the cell DTX/DRX configuration information; the UE does not perform the cell DTX/DRX operations on a first cell according to the cell DXT/DRX configuration information; the UE does not perform the cell DTX/DRX operations on a first cell and a second cell according to the cell DXT/DRX configuration information; the UE performs the cell DTX/DRX operations on a first cell according to the cell DXT/DRX configuration information for a first cell; the UE performs the cell DTX/DRX operations on a second cell according to the cell DXT/DRX configuration information for a first cell; the UE performs the cell DTX/DRX operations on a first cell and a second cell according to the cell DXT/DRX configuration information for a first cell.

In some embodiments, if a UE is provided with different cell DTX/DRX configuration information for PCell and SCell, the UE may not perform the cell DTX/DRX operations on a second cell according to the cell DXT/DRX configuration information.

In some embodiments, the cell DTX/DRX cycle on the first cell is larger than or equal to the cell DTX/DRX cycle on the second cell.

In some embodiments, the cell DTX/DRX on-duration on the first cell is larger than or equal to the cell DTX/DRX on-duration on the second cell.

In accordance with an embodiment of the invention, for Carrier Aggregation (CA), at least one of the following events occurred: for cross-carrier scheduling, the second cell is not provided by the cell DTX/DRX configuration; for cross-carrier scheduling, the first cell is not provided by the cell DTX/DRX configuration; the detection of DCI format 2-6, and/or Scell dormancy/non-dormancy behavior indication, and/or the UE DRX group configuration is not supported or is suspended by a first cell and/or a second cell; at least one of parameters related to the UE DRX configuration on a first cell and/or a second cell do not aligned or are not needed to be set to the same values; the start offset and/or cycle and/or on-duration of the cell DTX/DRX configuration on the first cell is larger than or equal to the start offset and/or cycle and/or on-duration of the cell DTX/DRX configuration on the second cell.

In some embodiments, the first cell is a primary cell and the second cell is secondary cell; and/or the first cell is a secondary cell and the second cell is another secondary cell; and/or the first cell is a scheduling cell and the second cell is a scheduled cell; and/or the first cell and the second cell are the same cell; and/or the first cell is a PScell and the second cell is a secondary cell; and/or the first cell is a Pcell and the second cell is a PScell.

In some embodiments, for the UE configured with CA, the UE DRX configuration information and/or the cell DTX/DRX configuration information for a first cell and second cell may be the same.

In some embodiments, for the UE configured with CA, DCI format 2-6 and the cell DTX/DRX configuration information may not be configured together.

In accordance with an embodiment of the invention, if the UE detects a DCI scheduling a data in a first cell that may be transmitted during a cell DTX/DRX off-duration on the second cell, the UE may perform at least one of the next actions: the UE receives or transmits data according to the scheduling information; the UE receives or transmits data during the cell DTX/DRX on-duration and/or active time in the next the cell DTX/DRX cycle according to the scheduling information; the UE assumes that the data scheduling information is invalid; the data scheduling information is ignored or is not expected by UE; and/or the UE sends a request for the cell DTX/DRX configuration on the scheduled cell or SCell.

In view of the above, it is possible to ensure that the scheduled data 1s transmitted/received by the UE as soon as possible.

For example, if UE is configured with deactivating a cell DTX/DRX functionality in the PCell and UE is configured with a cell DTX/DRX pattern in a SCell, the UE ignores the cross-carrier scheduling information for data transmitted/received in the SCell when the UE detects a PDCCH in the PCell carrying cross-carrier scheduling information and the SCell is the scheduled cell.

For example, if the UE is configured with cell DTX/DRX pattern in both PCell and SCell and the start or end or length of cell DTX/DRX on duration between PCell and SCell is not align, the UE assumes that the cell DTX/DRX active time is extended to slot n in the PCell when the UE needs to perform periodic CSI measurement/report in PCell to achieve synchronization for an UL-only SCell at slot n where is during cell DTX/DRX non active period of PCell and during cell DTX/DRX active time of SCell.

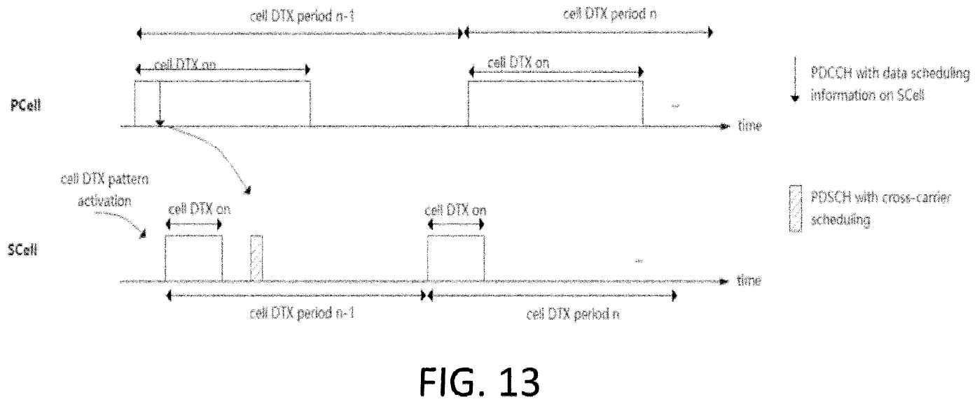

FIG. 13 shows an example of the data scheduling information on PCell that indicates a data reception during the cell DTX off-duration on SCell for a UE according to an embodiment of the present disclosure. Afterwards, the UE receives the PDSCH during the cell DTX off-duration on the SCell according to the data scheduling information.

In accordance with an embodiment of the invention, if a UE is provided by the cell DTX/DRX configuration information, the UE performs the next action related to CSI report when a predefined condition is met.

In some embodiments, the predefined condition may be at least one of the following: the UE is configured by a higher layer parameter; the UE is configured to report a CSI report with specific quantities; the most recent CSI measurement occasion occurs in a time duration associated with the cell DTX/DRX cycle, and/or the cell DTX/DRX on-duration, and/or the cell DTX/DRX off-duration, and/or the UE DRX cycle, and/or the UE DRX on-duration timer for CSI to be reported; the UE receives at least one CSI-RS transmission occasion for channel measurement and CSI-RS and/or CSI-IM occasion for interference measurement during the time duration no later than CSI reference resource; the UE receives at least one CSI-RS transmission occasion for each CSI-RS resource in a Resource Pair within the time duration no later than CSI reference resource; the UE receives at least one CSI-RS transmission occasion for channel measurement during the time duration no later than CSI reference resource; the UE is configured by higher layer parameter to report L1-RSRP (e.g., the UE Is configured by higher layer parameter ps-TransmitPeriodicL1-RSRP to report L1-RSRP); the CSI report is set to “periodic” or ‘semi-persistent’ (e.g., the UE is configured by higher layer parameter reportConfigType set to ‘periodic’); the UE is configured by higher layer parameter reportQuantity set to specific quantities; the UE is configured to monitor DCI format 2-6; DRX cycle in use is larger than 80 milliseconds; the UE detects DCI format 2-6 which indicates “not wake-up indication”; drx-onDurationTimer is not started; the UE is configured with Cell DTX; the UE is configured with Cell DRX; the UE is configured to transmit SRS.

In some embodiments, m addition to the above list, the predefined condition may further comprise at least one of the following conditions related to the MAC layer:
the UE is not satisfied with at least one of the following conditions: drx-onDurationTimer associated with the current DRX cycle is not started; and/or DRX is not in the UE DRX active time; and/or the UE DRX Command MAC CE/Long DRX Command MAC CE is received; and/or Scheduling Request is sent prior to the occasion/slot/symbol when evaluating all UE DRX Active Time conditions; and/or the UE may not reports periodic CSI on PUCCH or semi-persistent CSI on PUSCH; and/or the UE may not transmit SRS. In some embodiments, the SRS is periodic or semi-persistent.
the UE is not satisfied with the following conditions: in current symbol n, if a UE DRX group would not be in Active Time considering grants/assignments scheduled on Serving Cell(s) in this UE DRX group and the UE DRX Command MAC CE/Long DRX Command MAC CE received and Scheduling Request sent until 4 ms prior to symbol n when evaluating all UE DRX Active Time conditions.
the UE Is not satisfied with the following conditions: if allow CSI-SRS-Tx-MulticastDRX-Active is not configured or, in current symbol n, if all multicast UE DRXes corresponding to the UE DRX group would not be in Active Time considering multicast assignments and UE DRX Command MAC CE for MBS multicast received until 4 ms prior to symbol n when evaluating all UE DRX Active Time conditions and all multicast sessions corresponding to the UE DRX group are configured with multicast UE DRX.
the UE is not satisfied with the following conditions: if CSI masking (csi-Mask) is setup by upper layers: in current symbol n, if drx-onDurationTimer of a UE DRX group would not be running considering grants/assignments scheduled on Serving Cell(s) in this UE DRX group and UE DRX Command MAC CE/Long DRX Command MAC CE received until 4 ms prior to symbol n when evaluating all UE DRX Active Time conditions; and if allowCSI-SRS-Tx-MulticastDRX-Active is not configured or, m current symbol n, if drx-onDurationTimerPTM(s) of all multicast UE DRXes corresponding to the UE DRX group would not be running considering multicast assignments and UE DRX Command MAC CE for MBS multicast received until 4 ms prior to symbol n when evaluating all DRX Active Time conditions and all multicast sessions corresponding to the UE DRX group are configured with multicast DRX.
the UE reports CSI on PUCCH and/or PUSCH; and/or the UE transmits periodic SRS and semi-persistent SRS; and/or the UE reports CSI on PUCCH and semi-persistent CSI configured on PUSCH.

In some embodiments, the next action is at least one of the following: the UE reports a CSI report with specific quantities; the UE performs CSI measurements based on CSI measurement occasions during a time duration associated with the cell DTX/DRX cycle, and/or the cell DTX/DRX on-duration, and/or the cell DTX/DRX off-duration, and/or UE DRX cycle, and/or UE DRX on-duration timer; the UE performs measurement based on CSI-RS-Resource-Mobility; the UE assumes that the DRX on-duration timer during the cell DTX/DRX off-duration belongs to UE DRX active time or the cell DTX/DRX active time; the UE transmits SRS during a time duration associated with cell DTX/DRX cycle, and/or cell DTX/DRX on duration, and/or cell DTX/DRX off duration, and/or UE DRX cycle, and/or UE DRX on duration timer; the UE transmits SRS.

In some embodiments, the UE does not require to perform measurement based on CSI-RS-Resource-Mobility other than during a timer duration associated with the cell DTX/DRX cycle, and/or the cell DTX/DRX on-duration, and/or the cell DTX/DRX off-duration, and/or the UE DRX cycle, and/or the UE DRX on-duration timer.

In some embodiments, the specific quantities include at least one of the following: any of the quantities for CSI report; CSI with ‘periodic’ type and set to quantities other than ‘cri-RSRP’ and ‘ssb-Index-RSRP’; L1-RSRP with ‘periodic’ type and set to cri-RSRP; ‘cri-RSRP’; ‘ssb-Index-RSRP’; ‘cri-RSRP-Capability [Set] Index’; ‘ssb-Index-RSRP-Capability [Set] Index’.

In some embodiments, the time duration associated with the cell DTX/DRX cycle, and/or the cell DTX/DRX on-duration, and/or the cell DTX/DRX off-duration, and/or the UE DRX cycle, and/or the UE DRX on-duration timer is at least one of the following durations:
1—the cell DTX/DRX active time;
2—outside cell DTX/DRX active time; or the cell DTX/DRX outside-active-time; or the cell DTX/DRX non active period;
3—the cell DTX/DRX off-duration;
4—the cell DTX/DRX on-duration;
5—the UE DRX active time;
6—the timer duration indicated by drx-onDurationTimer in DRX-Config also outside the UE DRX active time;
7—the timer duration indicated by drx-onDurationTimer in DRX-Config in the cell DTX/DRX outside-active-time and/or the cell DTX/DRX off-duration;
8—the timer duration indicated by drx-onDurationTimer in DRX-Config also outside the UE DRX active time and also in the cell DTX/DRX outside-active-time and/or the cell DTX/DRX off-duration;
9—the timer duration indicated by drx-onDurationTimer in DRX-Config in the cell DTX/DRX active time and/or the cell DTX/DRX on-duration;
10—the timer duration indicated by drx-onDurationTimer in DRX-Config also outside the UE DRX active time and also in the cell DTX/DRX active time and/or the cell DTX/DRX on-duration;
11—the timer duration of the UE DRX active time in the cell DTX/DRX active time and/or the cell DTX/DRX on-duration;
12—the timer duration of the UE DRX active time m the cell DTX/DRX outside-active-time and/or the cell DTX/DRX off-duration;
13—the timer duration outside the UE DRX active time in the cell DTX/DRX active time and/or the cell DTX/DRX on-duration;
14—the timer duration outside the UE DRX active time m the cell DTX/DRX outside-active-time and/or the cell DTX/DRX off-duration;
15—the cell DTX/DRX outside-active-time and/or the cell DTX/DRX off-duration in the timer duration indicated by drx-onDurationTimer in DRX-Config;
16—the cell DTX/DRX outside-active-time and/or the cell DTX/DRX off-duration in the timer duration indicated by drx-onDurationTimer in DRX-Config also outside the UE DRX active time;
17—the cell DTX/DRX active time and/or the cell DTX/DRX on-duration in the timer duration indicated by drx-onDurationTimer in DRX-Config;
18—the cell DTX/DRX active time and/or the cell DTX/DRX on-duration in the timer duration indicated by drx-onDurationTimer in DRX-Config also outside the UE DRX active time;
19—the cell DTX/DRX active time and/or the cell DTX/DRX on-duration in the timer duration of the UE DRX active time;
20—the cell DTX/DRX outside-active-time and/or the cell DTX/DRX off-duration in the timer duration of the UE DRX active time;
21—the cell DTX/DRX active time and/or the cell DTX/DRX on-duration in the timer duration of outside the UE DRX active time;
22—the cell DTX/DRX outside-active-time and/or the cell DTX/DRX off-duration in the timer duration of outside the UE DRX active time.

In some embodiments, for example, if the UE is configured to monitor DCI indicating information related to the cell DTX/DRX and configured by higher layer parameter(s) to report a CSI (channel status information) report with specific quantities when the DTX off-duration is overlapped with the UE DRX active time, the most recent CSI measurement occasion occurs in the time duration of the UE DRX active time overlapped with the DTX off-duration for the CSI is reported. In some embodiments, the CSI report is CSI, or RSRQ (reference signal received quality), or RSSI (Received Signal Strength Indicator), or L1-RSRP (layer 1 reference signal received power).

In some embodiments, for the CSI-RS (channel status information reference signal) reception procedure, if the UE is configured with the cell DTX/DRX, the UE may perform the following operations:
if the UE is configured to monitor the DCI indicating information related to the cell DTX/DRX and configured by one or more higher layer parameters to report the CSI with “periodic” type and set to quantities other than “cri-RSRP” and “ssb-Index-RSRP” when the DTX off-duration is overlapped with the UE DRX active time, the most recent CSI measurement occasion occurs in the time duration of UE DRX active time overlapped with DTX off-duration for CSI is reported;
if the UE is configured to monitor DCI indicating information related to the cell DTX/DRX and configured by one or more higher layer parameters to report a L1-RSRP with ‘periodic’ type and set to cri-RSRP when the DTX off-duration is overlapped with the UE DRX active time, the most recent CSI measurement occasion occurs in the time duration of the UE DRX active time overlapped with the DTX off-duration for the CSI is reported;
otherwise, the most recent CSI measurement occasion occurs in the DTX on-duration for CSI is reported.

In some embodiments, as another example, if the UE is configured with the cell DTX/DRX, or when the UE is configured to monitor the DCI indicating information related to the cell DTX/DRX, or when the DTX cycle or the DTX on-duration or the DTX off-duration is larger than T, the UE may perform measurements and/or report a CSI report during the DTX on-duration or during the time duration of the UE DRX active time overlapped with the DTX off-duration. In some embodiments, T is not smaller than 80 ms. In some embodiments, the CSI report is CSI, or RSRQ, or RSSI, or L1-RSRP.

In some embodiments, for the CSI-RS for mobility, if the UE is configured with the cell DTX/DRX, the UE is not required to perform the measurement(s) of the CSI-RS resources other than during the DTX on-duration for measurements based on CSI-RS-Resource-Mobility. When the UE is configured to monitor the DCI indicating information related to the cell DTX/DRX, the UE is not required to perform measurements other than during the DTX on-duration and during the time duration of DTX off-duration overlapped with the UE DRX active time based on CSI-RS-Resource-Mobility.

In some embodiments, if the UE is configured with the cell DTX/DRX and the DTX cycle or the DTX on-duration in use is larger than 80 ms, the UE may not expect the CSI-RS resources are available other than during the DTX on-duration or the UE DRX active time or during the time duration of the UE DRX active time overlapped with the DTX off-duration for measurements based on CSJ-RS-Resource-Mobility. If the UE is configured with the cell DTX/DRX and configured to monitor the DCI indicating information related to the cell DTX/DRX and the DTX cycle or the DTX on-duration in use is larger than 80 ms, the UE may not expect that the CSI-RS resources are available other than during the DTX on-duration or the UE DRX active time or during the time duration of the UE DRX active time overlapped with the DTX off-duration for measurements based on CSI-RS-Resource-Mobility. Otherwise, the UE may assume CSI-RS are available for measurements based on CSJ-RS-Resource-Mobility.

In some embodiments, when the cell DTX/DRX is configured, the UE reports a CSI report only if receiving at least one CSI-RS transmission occasion for the channel measurement and the CSI-RS and/or CSI-IM occasion for the interference measurement in the DTX on-duration no later than the CSI reference resource and drops the report otherwise.

In some embodiments, when the cell DTX/DRX is configured and the CSI-RS Resource Set for the channel measurement corresponding to a CSI report is configured with two Resource Groups and N Resource Pairs, the UE reports a CSI report only if receiving at least one CSI-RS transmission occasion for each CSI-RS resource in a Resource Pair within the same DTX on-duration no later than the CSI reference resource and drops the report otherwise.

In some embodiments, when the UE is configured to monitor the DCI indicating information related to the cell DTX/DRX and if the UE configured by a higher layer parameter ps-TransmitOtherPeriodicCSI to report the CSI with the higher layer parameter reportConfigType set to “periodic” and reportQuantity set to quantities other than “cri-RSRP”, “ssb-Index-RSRP”, “cri-RSRP-Capability [Set] Index”, and “ssb-Index-RSRP-Capability [Set] Index” when the drx-onDurationTimer is not started, the UE may report the CSI during the time duration of the UE DRX active time overlapped with the DTX off-duration if receiving at least one CSI-RS transmission occasion for the channel measurement and the CSI-RS and/or CSI-IM occasion for the interference measurement during the time duration of the UE DRX active time overlapped with the DTX off-duration or in the UE DRX Active Time or in the DTX on-duration no later than the CSI reference resource and drops the report otherwise.

In some embodiments, when the UE is configured to monitor the DCI indicating information related to the cell DTX/DRX and if the UE configured by the higher layer parameter ps-TransmitPeriodicLI-RSRP to report L1-RSRP with the higher layer parameter reportConjigType set to “periodic” and reportQuantity set to “cri-RSRP”, “ssb-Index-RSRP”, “cri-RSRP-Capability[Set}Index”, or “ssb-Index-RSRP-Capability[Set}Index” when the UE DRX active time is overlapped with the DTX off-duration, the UE may report L1-RSRP during the time duration of the UE DRX active time overlapped with the DTX off-duration and when reportQuantity set to ‘cri-RSRP’ or ‘cri-RSRP-Capability/Set} Index’ if receiving at least one CSI-RS transmission occasion for the channel measurement during the time duration of the UE DRX active time overlapped with the DTX off-duration or in the UE DRX Active Time or in the DTX on-duration no later than the CSI reference resource and drops the report otherwise.

In some embodiments, DRX is a functionality that controls the UE's PDCCH monitoring activity for the MAC (Medium Access Control) entity's C-RNTI, CI-RNTI (Cancellation Indication RNTI), CS-RNTI, INT-RNTI (Interruption RNTI), SFI-RNTI (Slot Format Indication RNTI), SP-CSI-RNTI (Semi-Persistent CSI RNTI), TPC-PUCCH-RNTI (Transmit Power Control-PUCCH-RNTI), TPC-PUSCH-RNTI (Transmit Power Control-PUSCH-RNTI), TPC-SRS-RNTI (Transmit Power Control-Sounding Reference Symbols-RNTI), AI-RNTI (Availability Indication RNTI), SL-RNTI (Sidelink RNTI), SLCS-RNTI (Sidelink Configured Scheduling RNTI) and SL (Sidelink) Semi-Persistent Scheduling V-RNTI. When using the DRX operation, the MAC entity may also monitor the PDCCH according to the requirements. When in RRC_CONNECTED, if DRX is configured, for all the activated Serving Cells, the MAC entity may monitor the PDCCH discontinuously using the DRX operation; otherwise, the MAC entity may monitor the PDCCH in a different way.

In some embodiments, serving Cells of a MAC entity may be configured by the RRC in two DRX groups with separate DRX parameters. When the RRC does not configure a secondary DRX group, there is only one DRX group and all Serving Cells belong to that one DRX group. When two DRX groups are configured, each Serving Cell is uniquely assigned to either of the two groups. The DRX parameters that are separately configured for each DRX group can be: drx-onDurationTimer, and drx-InactivityTimer. The DRX parameters that are common to the DRX groups can be: drx-SlotO.fJset, drx-RetransmissionTimerDL, drx-RetransmissionTimerUL, drx-LongCycleStartO.fJset, drx-ShortCycle (optional), drx-ShortCycleTimer (optional), drx-HARQ-RTT-TimerDL, drx-HARQ-RTT-TimerUL, and uplinkHARQ-Mode (optional).

In some embodiments, DRX group indicates a group of Serving Cells that is configured by the RRC and that has the same DRX Active Time.

When DRX is configured, the Active Time for the Serving Cells in a DRX group includes the time while:
drx-onDurationTimer or drx-JnactivityTimer configured for the DRX group is running;
or
drx-RetransmissionTimerDL, drx-RetransmissionTimerUL or drx-RetransmissionTimerSL is running on any Serving Cell in the DRX group; or
ra-ContentionResolutionTimer or msgB-Response Window is running; or
a Scheduling Request is sent on the PUCCH and is pending; if this Serving Cell is part of a non-terrestrial network, the Active Time is started after the first Scheduling Request transmission plus the UE-gNB RTT; or
a PDCCH indicating a new transmission addressed to the C-RNTI of the MAC entity has not been received after successful reception of a Random Access Response for the Random Access Preamble not selected by the MAC entity among the contention-based Random Access Preamble.

In accordance with an embodiment of the invention, jointly configuration of adaptation of DL common and broadcast signals and DTX/DRX operation can be performed as follows:
For connected mode UE: a cell DRX/DTX is configured and SSB/SIB I-less cell is performed during outside DTX/DRX active time.
For idle mode UE: a cell DRX/DTX is configured and simplified SSB or a SSB with larger periodicity is configured during outside DTX/DRX active time.

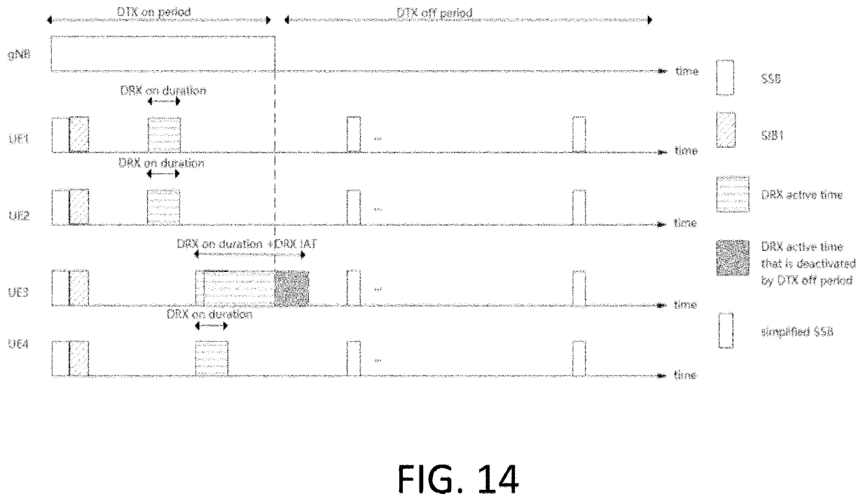

FIG. 14 shows an example of the cell DTX/DRX in accordance with an embodiment of the present disclosure. As shown in FIG. 14, a part of the DRX active time of UE3 can be deactivated based on the DTX off-period.

With configurations of at least one embodiment above, it is possible to ensure a longer sleep period for the gNB. For legacy UE or UEs not supporting DTX/DRX operations, this can also aid the UEs to access the cell with the cell DTX/DRX.

In some embodiments, during outside of DRX active time, SSB/SIB transmission configured by RRC signaling is stopped, and/or adaptation of SSB/SIB transmission is configured/indicated for one or more UEs.

In some embodiments, adaptation of DL common and broadcast signals can be triggered by the end/stop/expiration of DRX on-duration timer, the end/stop of DRX inactivity timer, the end/stop/expiration of DRX RTT timer/DRX retransmission timer, the end of DRX active time, or the start of outside of DRX active time.

A wireless communication method is also provided according to an embodiment of the present disclosure. In an embodiment, the wireless communication method may be performed by using a wireless communication terminal (e.g., a UE). In an embodiment, the wireless communication terminal may be implemented by using the wireless communication terminal 40 described above, but is not limited thereto.

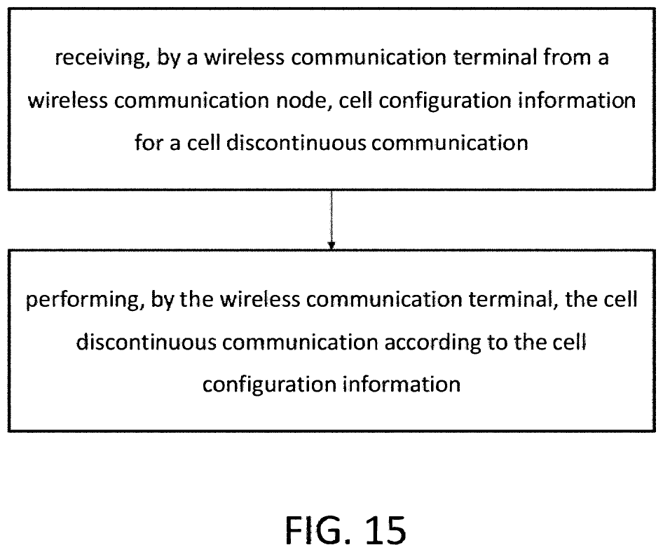

Referring to FIG. 15, in an embodiment, the wireless communication method includes: receiving, by a wireless communication terminal from a wireless communication node, cell configuration information for a cell discontinuous communication; and performing, by the wireless communication terminal, the cell discontinuous communication according to the cell configuration information.

In some embodiments, the cell configuration information may be the cell DTX/DRX configuration information described above.

In some embodiments, the cell discontinuous communication may be the cell DTX/DRX described above or the operations of the UE and/or gNB performs for the cell DTX/DRX described above.

Details in this regard can be ascertained with reference to the paragraphs above, and will not be repeated herein.

Another wireless communication method is also provided according to an embodiment of the present disclosure. In an embodiment, the wireless communication method may be performed by using a wireless communication node (e.g., a gNB or a BS). In an embodiment, the wireless communication node may be implemented by using the wireless communication node 50 described above, but is not limited thereto.

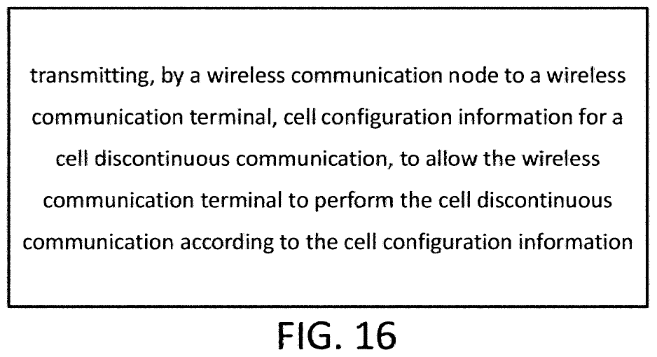

Referring to FIG. 16, in an embodiment, the wireless communication method includes transmitting, by a wireless communication node to a wireless communication terminal, cell configuration information for a cell discontinuous communication, to allow the wireless communication terminal to perform the cell discontinuous communication according to the cell configuration information.

Details in this regard can be ascertained with reference to the paragraphs above, and will not be repeated herein.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand example features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described example embodiments.

It is also understood that, as used herein, including in the claims, “or” as used in a list of items (e.g., a list of items prefaced by a phrase such as “at least one of” or “one or more of”) indicates an inclusive list such that, for example, a list of at least one of A, B or C means A or B or C or AB or AC or BC or ABC (i.e., A and Band C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” may be construed in the same manner as the phrase “based at least in part on.”

It is also understood that, as used herein, including in the claims, A is “associated with” or “related to” B may indicate that A includes B or B includes A or A includes at least one of B or B includes at least one of A.

It is also understood that, the base station (BS) may mean that a communication node, or BTS (Base Transceiver Station) in 2G, or NodeB in 3G, or eNB (E-UTRAN NodeB/enhanced NodeB) in 4G, or gNB (gNodeB) in 5G, or a base station of LTE (Long term evolution) or NR (New Radio access technology), or a base station of further generation communication system, or a cell with a normal state or activated state or deactivated state or dormant state, or a cell providing basic coverage, or a cell boosting capacity, or a small cell, or a primary cell, or a secondary cell.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according to embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

What is claimed is:

1. A wireless communication method comprising:
receiving, by a wireless communication terminal from a wireless communication node, cell configuration information for a cell discontinuous communication; and
performing, by the wireless communication terminal, the cell discontinuous communication according to the cell configuration information.

2. The wireless communication method of claim 1, wherein the cell discontinuous communication comprises at least one of a discontinuous transmission (DTX) or a discontinuous reception (DRX).

3. The wireless communication method of claim 1, wherein for the cell discontinuous communication in a serving cell, during a cell discontinuous transmission active time, the wireless communication terminal performs at least one of:
monitoring a physical downlink control channel (PDCCH);
receiving a physical downlink shared channel (PDSCH);
transmitting a physical uplink control channel (PUCCH);
transmitting a physical downlink shared channel (PUSCH);
transmitting sounding reference signal (SRS) transmission;
performing channel state information (CSI) measurement;
reporting CSI report information;
monitoring a Random Access Response (RAR) or receiving an MsgB during a time window; or
starting, restarting, or keeping a first timer running,
wherein monitoring the PDCCH comprises at least one of monitoring a first PDCCH or monitoring a second PDCCH.

4. The wireless communication method of claim 1, wherein one or more configuration parameters of the cell discontinuous communication satisfy at least one of:
a length of a cell discontinuous communication cycle, on-duration, or off-duration is equal to a multiple of a value of one or more UE DRX parameters;
a length of a cell discontinuous communication cycle, on-duration, or off-duration is not shorter than 2 ms or is not greater than a product of n and 10240 ms, and n is an integer that is not smaller than 1;
a length of a cell discontinuous communication cycle, on-duration, or off-duration is an integer of δ*2\hat{ }m of symbols, slots, or milliseconds, wherein 8 is one of the following: 1, 3, 5, 7, 15, and 35, and wherein m is an integer that is not smaller than 0 and is not larger than 20; or
a length of a cell discontinuous communication cycle, on-duration, or off-duration is n* 1/32 millisecond, wherein n is a positive integer that is not larger than 31.

5. The wireless communication method of claim 1, wherein one or more configuration parameters of the cell discontinuous communication satisfy at least one of:
one or more configuration parameters of a cell DTX are identical to one or more configuration parameters of a cell DRX; or
one or more candidate values of one or more configuration parameters for a cell DTX in one or more configuration sets are identical to one or more candidate values of one or more configuration parameters of a cell DRX in the one or more configuration sets.

6. The wireless communication method of claim 1, wherein a value of a cell DTX/DRX cycle or DTX/DRX on-duration or the cell DTX/DRX off-duration is configured as a multiple of the value of the UE DRX parameters, or the value of the UE DRX parameters is divisible by the value of the cell DTX/DRX cycle or DTX/DRX on-duration or the cell DTX/DRX off-duration.

7. The wireless communication method of claim 1, wherein a value of a cell DTX/DRX cycle or DTX/DRX on-duration or the cell DTX/DRX off-duration is an integer in form of δ*2\hat{ }m.

8. The wireless communication method of claim 7, wherein if a UE long DRX cycle is set to 60 ms, the cell DTX/DRX cycle is set to 120 ms, 180 ms or 300 ms.

9. The wireless communication method of claim 1, wherein if a UE long DRX cycle is set to 10240 ms, the cell DTX/DRX cycle can be set to 5120 ms, or 2048 ms that the UE long DRX cycle is divisible by the cell DTX/DRX cycle, or 20480 ms, 40960 ms, or 51200 ms that is a multiple of the UE DRX cycle.

10. The wireless communication method of claim 1, wherein a candidate value of a cell DTX/DRX cycle and/or a cell DTX/DRX on-duration and/or a cell DTX/DRX off-duration includes at least one of the candidate values of the UE long DRX cycle and/or the UE short DRX cycle.

11. A wireless communication method comprising:
transmitting, by a wireless communication node to a wireless communication terminal, cell configuration information for a cell discontinuous communication, to allow the wireless communication terminal to perform the cell discontinuous communication according to the cell configuration information.

12. The wireless communication method of claim 11, wherein the cell discontinuous communication comprises at least one of a discontinuous transmission (DTX) or a discontinuous reception (DRX).

13. The wireless communication method of claim 11, wherein one or more configuration parameters of the cell discontinuous communication satisfy at least one of:
a length of a cell discontinuous communication cycle, on-duration, or off-duration is equal to a multiple of a value of one or more UE DRX parameters;
a length of a cell discontinuous communication cycle, on-duration, or off-duration is not shorter than 2 ms or is not greater than a product of n and 10240 ms, and n is an integer that is not smaller than 1;
a length of a cell discontinuous communication cycle, on-duration, or off-duration is an integer of δ*2\hat{ }m of symbols, slots, or milliseconds, wherein 8 is one of the following: 1, 3, 5, 7, 15, and 35, and wherein m is an integer that is not smaller than 0 and is not larger than 20; or
a length of a cell discontinuous communication cycle, on-duration, or off-duration is n* 1/32 millisecond, wherein n is a positive integer that is not larger than 31.

14. The wireless communication method of claim 11, wherein a value of a cell DTX/DRX cycle or DTX/DRX on-duration or the cell DTX/DRX off-duration is configured as a multiple of the value of the UE DRX parameters, or the value of the UE DRX parameters is divisible by the value of the cell DTX/DRX cycle or DTX/DRX on-duration or the cell DTX/DRX off-duration.

15. The wireless communication method of claim 11, wherein a value of a cell DTX/DRX cycle or DTX/DRX on-duration or the cell DTX/DRX off-duration is an integer in form of δ*2\hat{ }m.

16. The wireless communication method of claim 15, wherein if a UE long DRX cycle is set to 60 ms, the cell DTX/DRX cycle is set to 120 ms, 180 ms or 300 ms.

17. The wireless communication method of claim 11, wherein if a UE long DRX cycle is set to 10240 ms, the cell DTX/DRX cycle can be set to 5120 ms, or 2048 ms that the UE long DRX cycle is divisible by the cell DTX/DRX cycle, or 20480 ms, 40960 ms, or 51200 ms that is a multiple of the UE DRX cycle.

18. The wireless communication method of claim 11, wherein a candidate value of a cell DTX/DRX cycle and/or a cell DTX/DRX on-duration and/or a cell DTX/DRX off-duration includes at least one of the candidate values of the UE long DRX cycle and/or the UE short DRX cycle.

19. A wireless communication terminal comprising:
a communication unit; and
at least one processor configured to:
receive, via the communication unit from a wireless communication node, cell configuration information for a cell discontinuous communication; and perform the cell discontinuous communication according to the cell configuration information.

20. A wireless communication node comprising: a communication unit; and at least one processor configured to perform the method of claim 11.
